(19) United States
(12) Patent Application Publication
(10) Pub. No.: US 2007/0217855 A1
(43) Pub. Date: Sep. 20, 2007

(54) Information processing apparatus and control device

(76) Inventor: Hiroshi Morohoshi, Kanagawa (JP)

Correspondence Address: COOPER & DUNHAM, LLP, 1185 AVENUE OF THE AMERICAS, NEW YORK, NY, 10036, US

(21) Appl. No.: 11/717,447

(22) Filed: Mar. 12, 2007

(30) Foreign Application Priority Data
Mar. 15, 2006 (JP) 2006-071043
Mar. 31, 2006 (JP) 2006-099491

(51) Int. Cl. B41J 29/00

(52) U.S. Cl. 400/716

(57) ABSTRACT

An information processing apparatus includes an electronic paper capable of displaying target data to be displayed and a control device that performs a control of processing. The electronic paper includes a display unit that can electrically display and erase the target data and a first communication unit that exchanges data with the control device. The control device includes a storage unit that stores the target data, a display control unit that controls the display unit to display the target data stored in the storage unit, and a second communication unit that exchanges data with the electronic paper.

### CROSS-REFERENCE TO RELATED APPLICATIONS

The present document incorporate by reference the entire contents of Japanese priority documents, 2006-071043 filed in Japan on Mar. 15, 2006, and 2006-099491 filed in Japan on Mar. 31, 2006.

### BACKGROUND OF THE INVENTION

1. Field of the Invention

The present invention relates to an information processing apparatus including electronic paper capable of displaying data to be displayed and a control device that processes the electronic paper, and a control device, and, more particularly to electronic paper having a display unit capable of electrically displaying data to be displayed and erasing data, and control of display processing of the electronic paper.

2. Description of the Related Art

Conventionally, a paper medium is used as an information transmission medium. However, the paper medium can hold only physical printed information, and has a problem of a reduction in portability when transmitting information using many paper mediums.

On the other hand, notebook personal computers (PCs) are popular recently as information transmission means having excellent portability. However, while the notebook PC has excellent portability, it is necessary to secure a power supply to the PC. Further, to transmit information to other person, other means such as electronic mail needs to be used. Consequently, information transmission processes are complicated.

In recent years, Universal Serial Bus (USB) memory has been popular as information holding means. The USB memory is a low-cost and handy storage medium capable of holding data. However, the USB memory cannot directly display data stored therein, and has poor transmissibility of information.

To solve the above difficulties, a paper-shaped display having flexibility of displaying data, that is, electronic paper, has been developed recently. For example, related techniques are disclosed in Japanese Patent Application Laid-open No. 2003-122266 and National Publication No. 2002-543625.

The above conventional electronic paper has information transmissibility by displaying data on a paper-shaped-display. However, to display many data elements, a device that stores a large amount of data and controls the display is necessary, and the device has to be excessively large.

Therefore, a user needs to carry both the electronic paper and the excessively large device that controls the display. This method has a problem in that it is difficult to carry both the electronic paper and the display control device, and that data cannot be easily delivered instantly.

Meanwhile, an image processing apparatus such as a printer provided recently has many functions to execute image processing, image output or the like. Such an image processing apparatus has complex functions in many cases. A manual attached to the image processing apparatus such as a printer is necessary to check details of the complex functions. The manual includes a paper manual printed on a paper medium, and electronic manuals such as a compact-disc read only memory (CD-ROM) and World Wide Web (Web).

However, when the apparatus has many functions, the paper manual becomes a voluminous manual because of many pages (sheets) required to explain the functions. Because the manual has a large weight, it is difficult to always carry this manual. In the case of the electronic manual, the user cannot read the manual where a personal computer (PC) is not installed. Therefore, the user needs to read the electronic manual at a place where the PC is present. Accordingly, the electronic manual cannot be referred instantly.

To solve the above difficulties, a technique enabling a user to use complex functions of an apparatus is disclosed as follows. An apparatus such as a printer holds a manual of the printer inside the apparatus. A user can obtain information included in the manual of the image processing device, by outputting the manual from the apparatus such as the printer, without carrying a voluminous manual or without requiring installation of a PC. In other words, according to a technique disclosed in Japanese Patent Laid-open No. 8-174967, when a user selects a number of a manual that the user wishes to read from an operation panel, the manual is printed or is displayed on the operation panel, and then the user can read the manual.

However, according to the technique disclosed in Japanese Patent Laid-open No. 8-174967, the user needs to search and select a position where desired information is present, and this imposes a large load on the user. Information needs to be printed out each time when the manual is referred, and the cost of printout increases. Further, when the information is displayed on the operation panel of the display, the user finds it difficult to read the manual, because the display part of the operation panel is small.

### SUMMARY OF THE INVENTION

It is an object of the present invention to at least partially solve the problems in the conventional technology.

An information processing apparatus according to one aspect of the present invention includes an electronic paper capable of displaying target data to be displayed and a control device that performs a control of processing. The electronic paper includes a display unit that can electrically display and erase the target data and a first communication unit that exchanges data with the control device. The control device includes a storage unit that stores the target data, a display control unit that controls the display unit to display the target data stored in the storage unit, and a second communication unit that exchanges data with the electronic paper.

An information processing apparatus according to another aspect of the present invention includes an electronic paper capable of displaying target data to be displayed and a control device that performs a control of processing. The electronic paper includes a storage unit that stores the target data, a display unit that can electrically display and erase the target data, and a first communication unit that exchanges data with the control device. The control device includes a display control unit that controls the display unit to display the target data stored in the storage unit and a second communication unit that exchanges data with the electronic paper.

An information processing apparatus according to still another aspect of the present invention includes an electronic paper capable of displaying target data to be displayed and a control device that performs a control of processing. The electronic paper includes a display unit that can electrically display and erase the target data, a display control unit that controls the display unit to display the target data stored in the control device, and a first communication unit that exchanges data with the control device. The control device includes a storage unit that stores the target data and a second communication unit that exchanges data with the electronic paper.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a configuration of an information processing apparatus according to a first embodiment of the present invention;

FIG. 2 is a side view of the information processing apparatus according to the first embodiment shown in FIG. 1;

FIG. 3 is a schematic of a state that electronic paper is taken out from a control device;

FIG. 4 is a cross-sectional view of an internal configuration of a display unit of the electronic paper;

FIG. 5 is a schematic for explaining a method of fitting the electronic paper and the control device;

FIG. 6 is a block diagram of a functional configuration of the electronic paper and the control device of the information processing apparatus according to the first embodiment;

FIG. 7 is a flowchart of a process procedure of displaying data performed by the information processing apparatus according to the first embodiment;

FIG. 8 is a schematic for explaining a first modified method of fitting the electronic paper and the control device;

FIG. 9 is a schematic for explaining a second modified method of fitting the electronic paper and the control device;

FIG. 10 is a schematic for explaining of a state that the number of holes and their intervals in the electronic paper are related to the FBA standard, thereby making it possible to fit the electronic paper of various kinds of sizes to the control device;

FIG. 11 is a schematic of a state that two pieces of electronic paper are fitted to the control device;

FIG. 12 is a block diagram of a functional configuration of the electronic paper and the control device that perform transmission/reception of data between each other using an interface of a radio LAN;

FIG. 13 is a schematic of a configuration of an information processing apparatus according to a second embodiment of the present invention;

FIG. 14 is a block diagram of a functional configuration of electronic paper and a control device of the information processing apparatus according to the second embodiment;

FIG. 15 is a flowchart of a process procedure of displaying data performed by the information processing apparatus according to the second embodiment;

FIG. 16 is a block diagram of a functional configuration of the electronic paper and the control device that perform transmission/reception of data between each other using an interface of a radio LAN;

FIG. 17 is a schematic of a configuration of an information processing apparatus according to a third embodiment of the present invention;

FIG. 18 is a block diagram of a functional configuration of electronic paper and a control device of the information processing apparatus according to the third embodiment;

FIG. 19 is a flowchart of a process procedure of displaying data performed by the information processing apparatus according to the third embodiment;

FIG. 20 is a block diagram of a functional configuration of the electronic paper and the control device that perform transmission/reception of data between each other using an interface of a radio LAN;

FIG. 21 is a schematic of a configuration of electronic paper;

FIG. 22 is a block diagram of a functional configuration of electronic paper according to a fourth embodiment of the present invention;

FIG. 23 is a flowchart of a process procedure of displaying data performed by the electronic paper according to the fourth embodiment;

FIG. 24 is a block diagram of a configuration of a display processing system according to a fifth embodiment of the present invention;

FIG. 25 is one example of a correspondence table stored in a storage unit;

FIG. 26 is a schematic of a configuration of an information processing apparatus;

FIG. 27 is one example of a table stored in an ID storage unit;

FIG. 28 is a sequence diagram of a display process procedure performed by the display processing system according to the fifth embodiment;

FIG. 29 depicts a using state of the display processing system according to the fifth embodiment;

FIG. 30 depicts a using state when the display processing system according to the fifth embodiment is applied to an air conditioning apparatus;

FIG. 31 depicts a using state of the display processing system according to the fifth embodiment when the system is applied to an automobile;

FIG. 32 depicts a using state when the display processing system according to the fifth embodiment is applied to a model of a human body;

FIG. 33 is a block diagram of a configuration of a display processing system according to a sixth embodiment of the present invention;

FIG. 34 is one example of a correspondence table stored in a storage unit;

FIG. 35 is a sequence diagram of a display process procedure performed by the display processing system according to the sixth embodiment;

FIG. 36 is a block diagram of a configuration of a display processing system according to a seventh embodiment of the present invention;

FIG. 37 is a sequence diagram of a display process procedure performed by the display processing system according to the seventh embodiment;

FIG. 38 is a block diagram of a hardware configuration of a multifunction product (MFP) according to the fifth to seventh embodiments;

FIG. 39 is a block diagram of a configuration of a display processing system according to an eighth embodiment of the present invention;

FIG. 40 is one example of an ID of a work such as a painting stored in an ID storage unit;

FIG. 41 is one example of a correspondence table stored in a storage unit;

FIG. 42 is a sequence diagram of a display process procedure performed by the display processing system according to the eighth embodiment;

FIG. 43 depicts a state of using the display processing system according to the eighth embodiment; and

FIG. 44 is a block diagram of a hardware configuration of an information processing apparatus according to the fifth to eighth embodiments.

### DETAILED DESCRIPTION OF THE PREFERRED EMBODIMENTS

Exemplary embodiments of the present invention are explained in detail below with reference to the accompanying drawings.

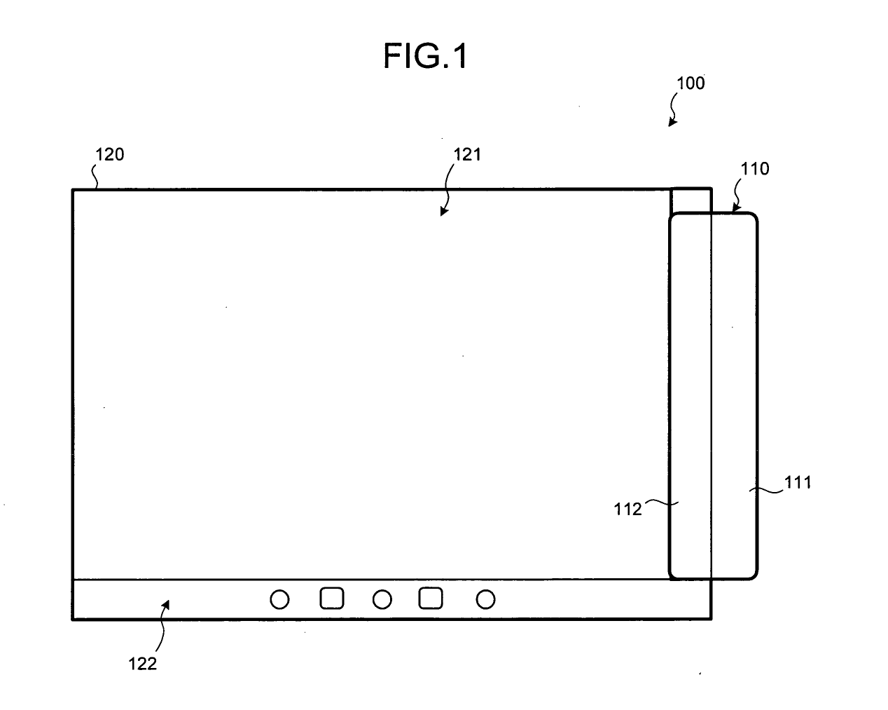

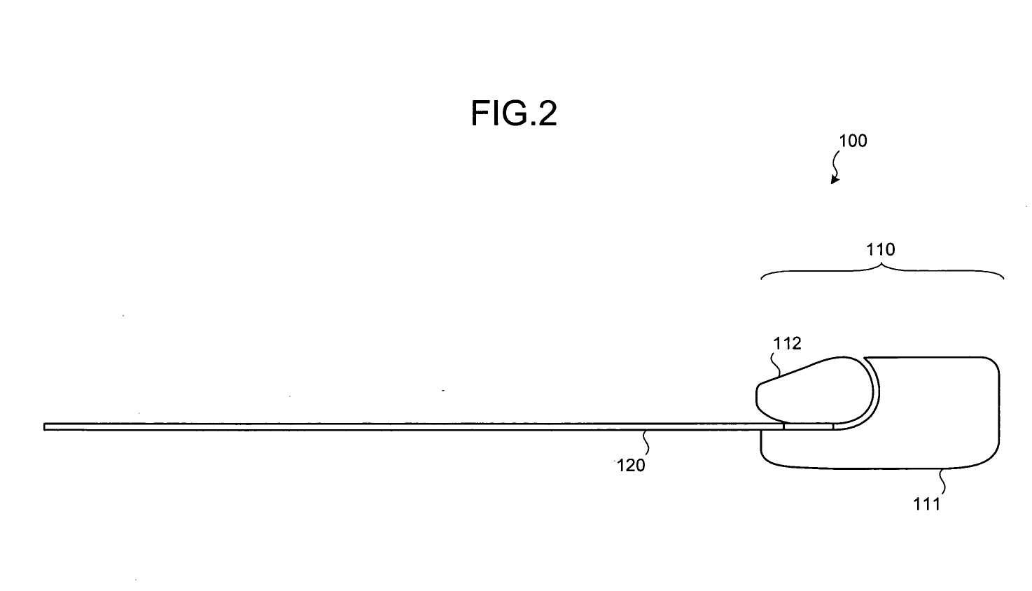

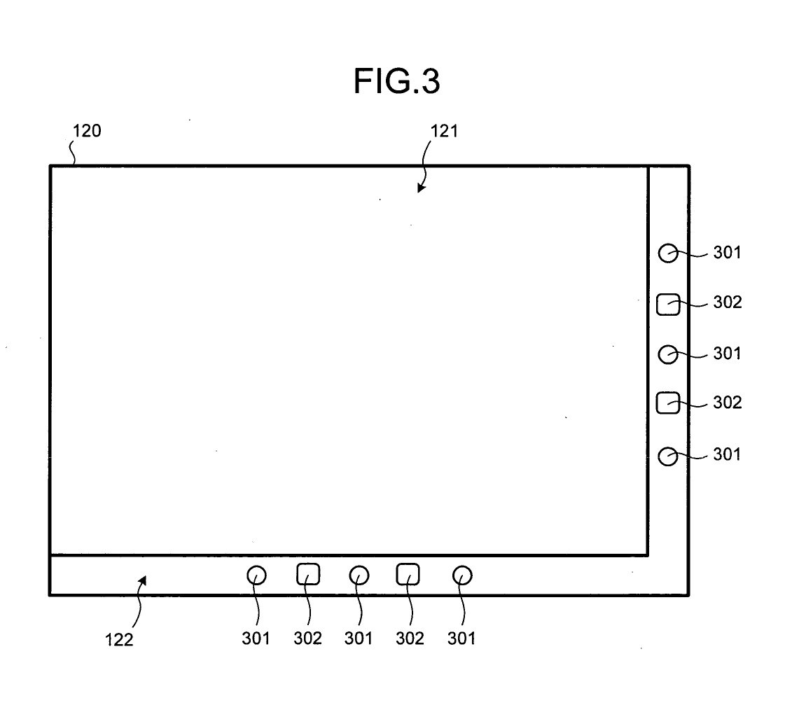

FIG. 1 is a schematic of a configuration of an information processing apparatus 100 according to a first embodiment of the present invention; and FIG. 2 is a side view of the information processing apparatus 100 according to the first embodiment shown in FIG. 1. As shown in FIG. 1, the information processing apparatus 100 according to the first embodiment includes an electronic paper 120, and a control device 110. The electronic paper 120 has a thickness of about a few tenths of millimeters, and has a display unit 121 that can display and erase data by an electric method. The electronic paper 120 is a reflection type display medium that is expected to achieve “coupling and rewritability of digital information” held by softcopy copied on a screen of the display unit and paper resource saving, in addition to “easiness of reading and carrying” held by hardcopy printed on a paper medium. In this way, the electronic paper 120 has characteristics of ultra-thinness and flexibility that are not possible to the conventional image information processing apparatus. The control device 110 controls display of data not displayed on the screen of the electronic paper 120, and mainly includes a body part 111 and a fitting part 112. The fitting part 112 is mounted with the electronic paper 120. As shown in FIG. 2, the control device 110 sandwiches the end of the electronic paper 120 between the body part 111 and the fitting part 112, thereby mounting the electronic paper 120 onto the fitting part 112. When the sandwiched state is canceled, the electronic paper 120 can be extracted and take out. FIG. 3 is a schematic of a state that the electronic paper 120 is taken out from the control device 110. The display unit 121 of the electronic paper 120 is mounted on a flexible plate member 122. Both the plate member 122 and the display unit 121 are made of a bendable material. Data can be displayed on and erased from the display unit 121.

To mount the electronic paper 120 onto the fitting part 112, the plate member 122 has three holes 301 at each of the right end and the lower end of the plate member 122 to engage projections (not shown) of the control device 110 with the holes 301, as shown in FIG. 3.

The plate member 122 has two electrode parts 302 at each of the right end and the lower end of the plate member, corresponding to positions of electrode parts (not shown) of the control device 110, as shown in FIG. 3. The electrode parts 302 receive data transmitted from the control device 110, in contact with the electrode parts of the control device 110. The electrode parts 302 carry out data communication with the electrode parts of the control device 110 using an USB interface (I/F).

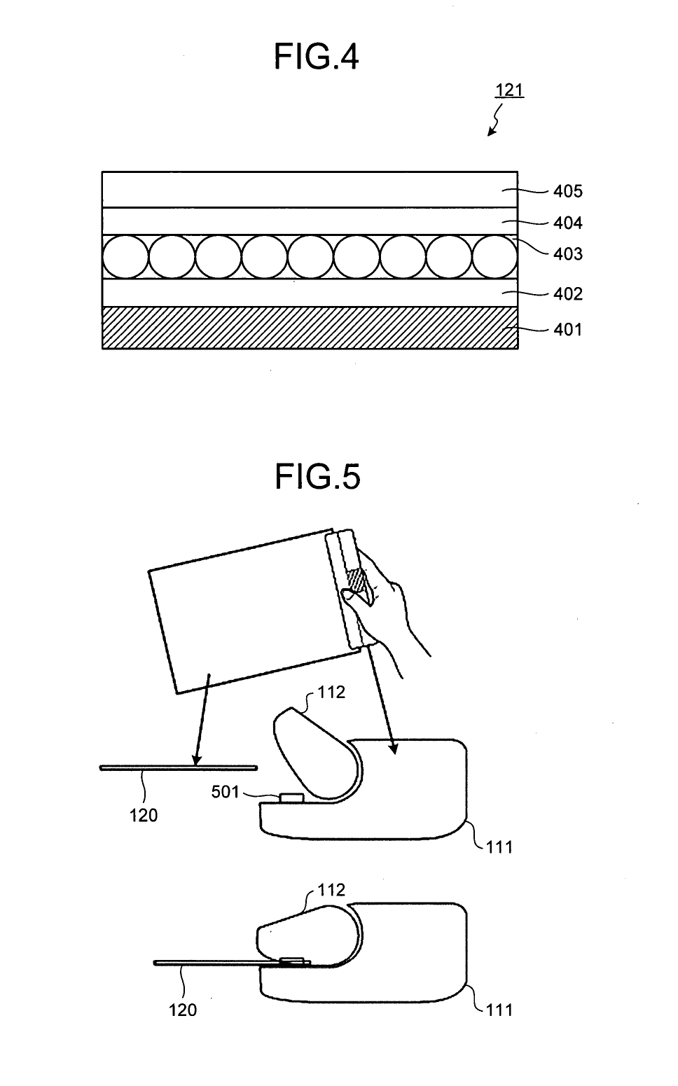

FIG. 4 is a cross-sectional view of an internal configuration of the display unit 121 of the electronic paper 120. As shown in FIG. 4, the display unit 121 of the electronic paper 120 includes a base material 401 having flexibility such as paper and plastics, an electrode film 402 having a conductive layer formed in a plastic film having excellent size stability such as polyethylene telephthalate (PET), polyethylene naphthalate (PEN), and polyimide, an image display layer 403, a transparent electrode film 404 having an active matrix electrode, a segment electrode, or a simple matrix electrode (not shown) formed in a transparent plastic film having excellent size stability such as PET, PEN, and polyimide, and an ultraviolet (UV) cut and protection layer 405 that protects the display unit, which are laminated in this order from the bottom. Because the display unit 121 has this configuration, the display screen of the display unit 121 maintains a displayed state even after a power supply unit is disconnected.

A method of fitting the electronic paper 120 and the control device 110 is explained next. FIG. 5 is a schematic for explaining the method of fitting the electronic paper 120 and the control device 110. As shown in FIG. 5, projections 501 are formed on the upper surface of the body part 111 of the control device 10, at the fitting part 112 side. The holes 301 of the electronic paper 120 are engaged with the projections 501 of the body part 111, in a state that the fitting part 112 is rotated above. The fitting part 112 is rotated downwards to sandwich the electronic paper 120 between the fitting part 112 and the body part 111. With this arrangement, the electronic paper 120 can be securely fitted to the control device 110. In this case, as described above, the electrode parts of the control device 110 maintain a contact with the electrode parts 302 of the electronic paper. Accordingly, the control device 110 can transmit display data to the electronic paper 120.

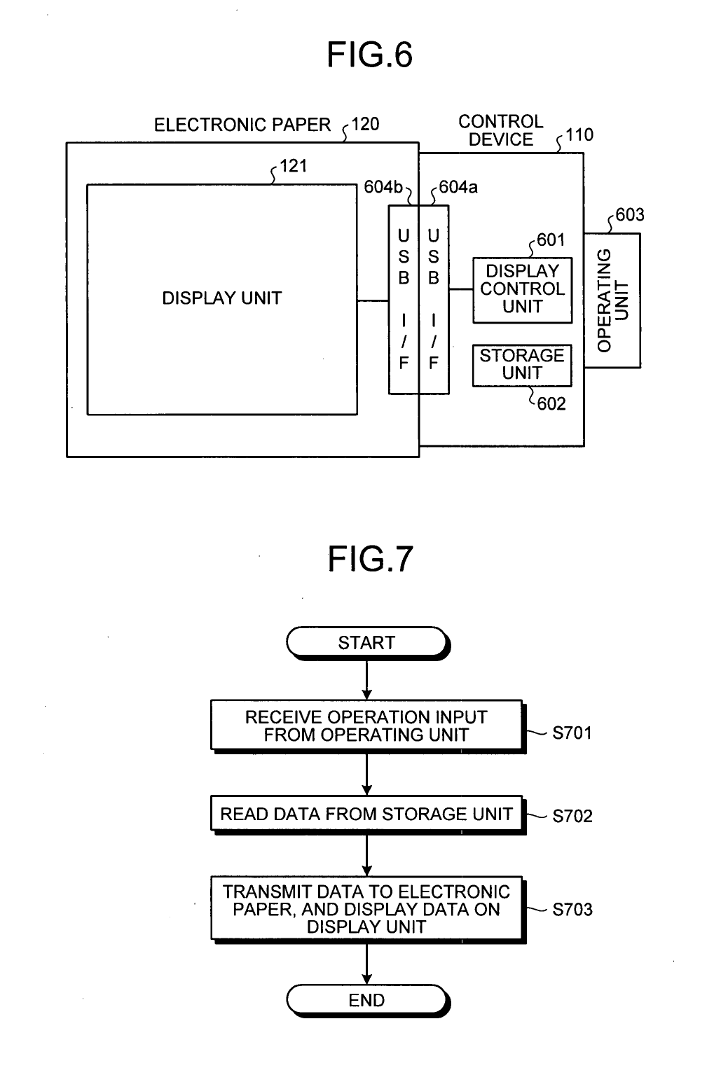

A functional configuration of the electronic paper 120 and the control device 110 of the information processing apparatus 100 according to the first embodiment is explained next. FIG. 6 is a block diagram of a functional configuration of the electronic paper 120 and the control device 110 of the information processing apparatus 100 according to the first embodiment.

The electronic paper 120 includes a USB I/F 604b having the electrode part 302, in addition to the display unit 121.

On the other hand, the control device 110 includes an operating unit 603, a display control unit 601, a storage unit 602, a USB I/F 604a, and a power supply unit (not shown).

The operating unit 603 receives an operation input from a user. The display control unit 601 controls the display of data to be displayed on the electronic paper 120 according to the operation input from the operating unit 603. The storage unit 602 is a storage medium such as a memory that stores data to be displayed. The storage unit 602 is a storage medium such as a memory that stores data to be displayed. The USB I/F 604a has an electrode part (not shown), and transmits various data such as display data and a display instruction to the display unit 121 of the electronic paper 120, together with the USB I/F 604b of the electronic paper 120.

The power supply unit supplies power to each part of the control device 110, and supplies power to the electronic paper 120 via the USB I/Fs 604a and 604b.

A display process of display data performed by the information processing apparatus 100 having the above configuration is explained next. FIG. 7 is a flowchart of a process procedure of displaying the data performed by the information processing apparatus 100 according to the first embodiment.

The control device 110 receives an operation input carried out by a user from the operating unit 603 (step S701). The display control unit 601 reads display data from the storage unit 602 (step S702). The display control unit 601 transmits the read display data to the display unit 121 of the electronic paper 120 via the USB I/Fs 604a and 604b, and displays the data in the display unit 121 (step S703).

As explained above, the information processing apparatus 100 according to the first embodiment carries a display control of reading display data stored in the storage unit 602 of the control device 110, and displaying the data in the bendable display unit 121 provided in the electronic paper capable of electrically displaying and erasing the display data, via the USB I/Fs 604a and 604b. Therefore, the information processing apparatus 100 can instantly deliver data to a third party by holding a large amount of data while maintaining information transmissibility and portability.

The information processing apparatus 100 according to the first embodiment engages the holes 301 at the electronic paper 120 side with the projection 501 at the control device 110 side, thereby making the electronic paper 120 and the control device 110 detachable. However, the method of fitting the electronic paper 120 and the control device 110 is not limited to this. The configuration is sufficient when both the electronic paper 120 and the control device 110 are detachable and when display data can be transmitted and received in the state that both are fitted together.

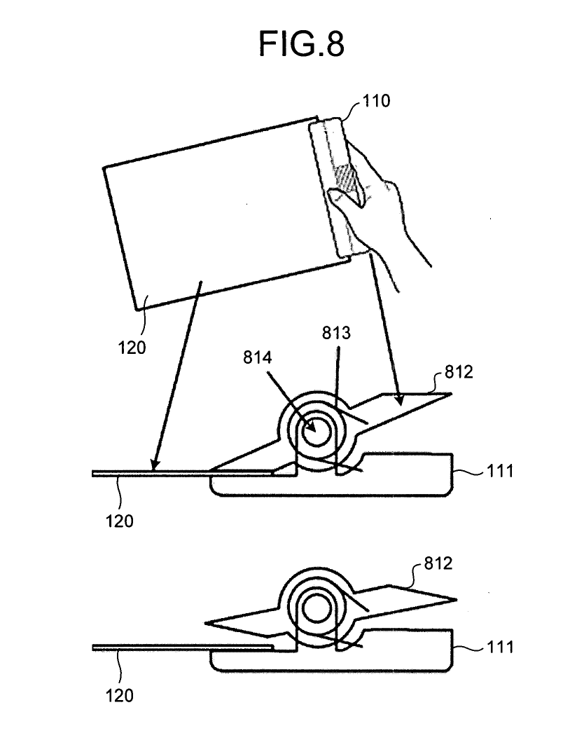

FIG. 8 is a schematic for explaining a first modified method of fitting the electronic paper 120 and the control device 110. As shown in FIG. 8, the fitting part 112 of the control device 110 includes a rotatable supporting part 812 and an elastic member 813 such as a spring that biases the end part of the electronic paper 12 of the supporting part 812 to the body part 111, around an axis part 814. The end of the electronic paper 120 is inserted into between the body part 111 and the supporting part 812. The elastic member 813 biases the supporting part 812 toward the body part 111, thereby sandwiching the end part of the inserted electronic paper 120. With this arrangement, the electronic paper 120 and the control device 110 can be detachably fitted together. In this case, holes are not necessary in the electronic paper 120, and the configuration of the electronic paper 120 can be simplified.

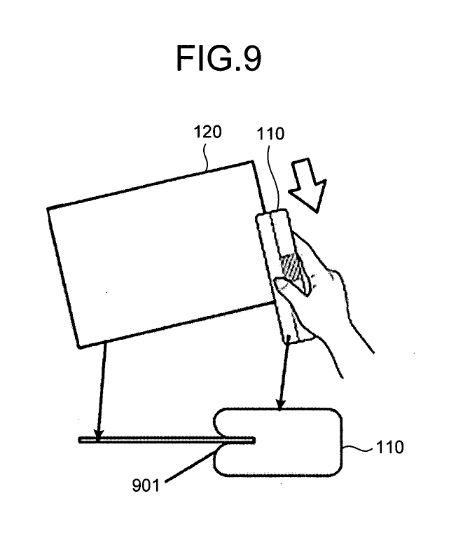

FIG. 9 is a schematic for explaining a second modified method of fitting the electronic paper 120 and the control device 110. As shown in FIG. 9, a recess part 901 is formed in the control device 110, and the electronic paper 120 is slid into the recess part 901, thereby detachably fitting the electronic paper 120 and the control device 110 together. In this case, holes are not necessary in the electronic paper 120. Therefore, the fitting part is not necessary in the control device 110 either, and the configuration of the electronic paper 120 and the control device 110 can be simplified.

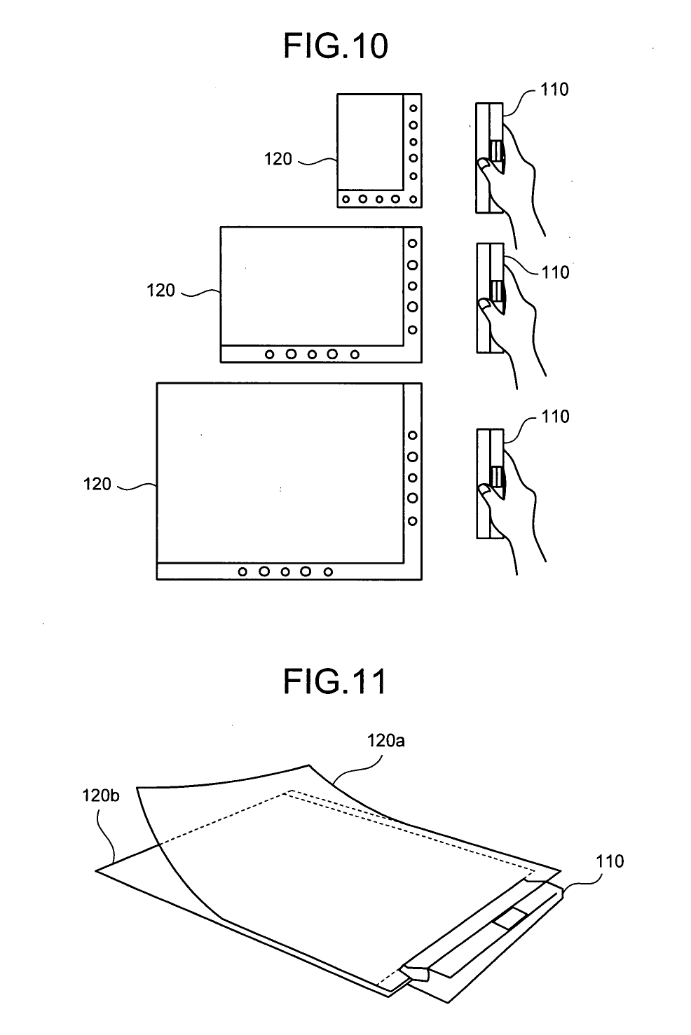

According to the first embodiment, while the hole 301 is provided at three parts of the plate member of the electronic paper 120, the number of the holes 301 is not limited to three. The hole 301 can be provided at one part, two parts, four parts, six parts, 26 parts, or 30 parts at intervals corresponding to the FBA standard prescribed by File & Binder Association Japan. When the number of holes and their intervals in the electronic paper 120 are provided corresponding to the FBA standard, the electronic paper 120 of various sizes can be fitted to the control device 110. FIG. 10 is a schematic for explaining a state that the number of holes and their intervals in the electronic paper 120 are related to the FBA standard, thereby making it possible to fit the electronic paper 120 of various kinds of sizes to the control device 110.

Furthermore, according to the first embodiment, while a single one of the electronic paper 120 is fitted to the control device 110, plural pieces of the electronic paper 120 can be also fitted to the control device 110 to constitute the control device 110. FIG. 11 is a schematic of a state that two electronic papers 120a and 120b are fitted to the control device 110.

Moreover, according to the first embodiment, while the USB I/Fs 604a and 604b achieve transmission/reception of the data between the electronic paper 120 and the control device 110, any interface that can achieve transmission/reception of data can be used. For example, an interface of a radio local area network (LAN) such as the Institute of Electrical and Electronics Engineers (IEEE) 802.11a and the IEEE 802.11b can be used to perform transmission/reception of data between the electronic paper 120 and the control device 110.

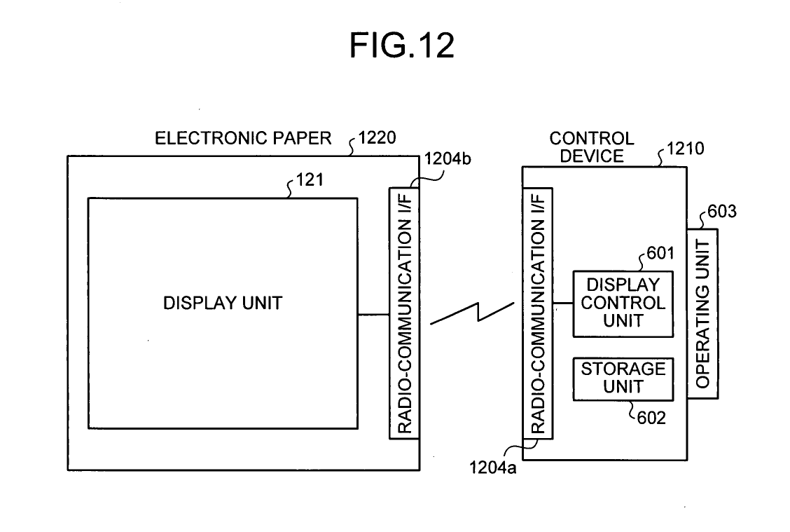

FIG. 12 is a block diagram of a functional configuration of an electronic paper 1220 and a control device 1210 that perform transmission/reception of data between the electronic paper 1220 and the control device 1210 using the interface of a radio LAN. In the example shown in FIG. 12, radio-communication I/Fs 1204a and 1204b as interfaces of a radio LAN such as the IEEE 802.11a and the IEEE 802.11b are provided in the control device 1210 and the electronic paper 1220, respectively, instead of the USB I/F. When this configuration is used, the electronic paper 1220 is completely isolated from the control device 1210. Therefore, it is easy to perform transmission/reception of data between a third party and the information processing apparatus 100, thereby further improving portability of the apparatus.

While the information processing apparatus 100 according to the first embodiment includes the storage unit in the control device 110, an information processing apparatus according to a second embodiment of the present invention includes a storage unit in electronic paper.

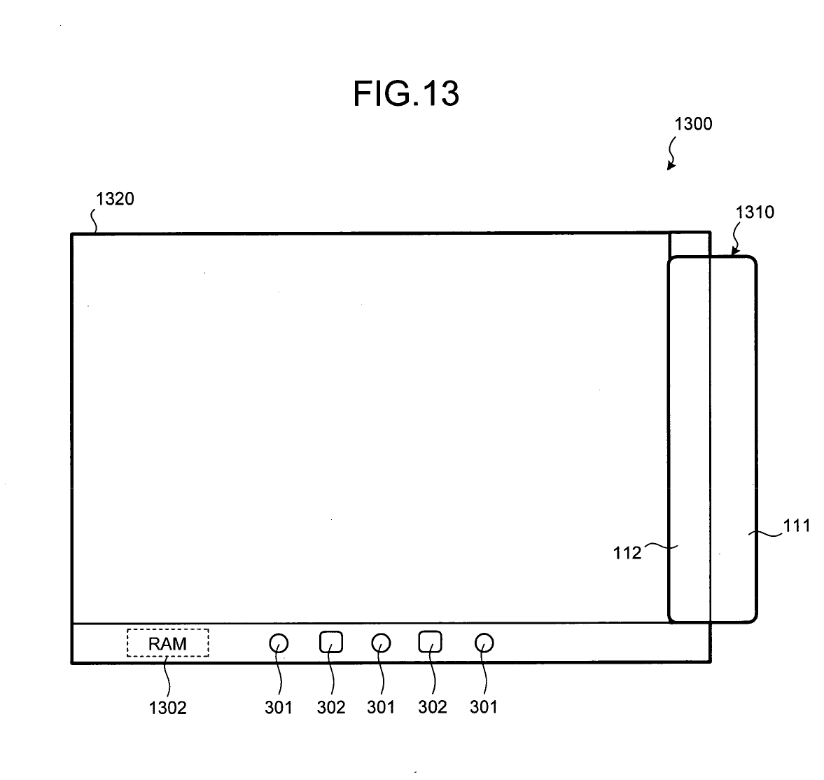

FIG. 13 is a schematic of a configuration of an information processing apparatus 1300 according to the second embodiment. The appearance of the information processing apparatus 1300 according to the second embodiment is identical to the information processing apparatus 100 of the first embodiment.

As shown in FIG. 13, the information processing apparatus 1300 according to the second embodiment includes an electronic paper 1320 and a control device 1310. In the second embodiment, a plate member of the electronic paper 1320 includes a random access memory (RAM) (a storage unit) 1302.

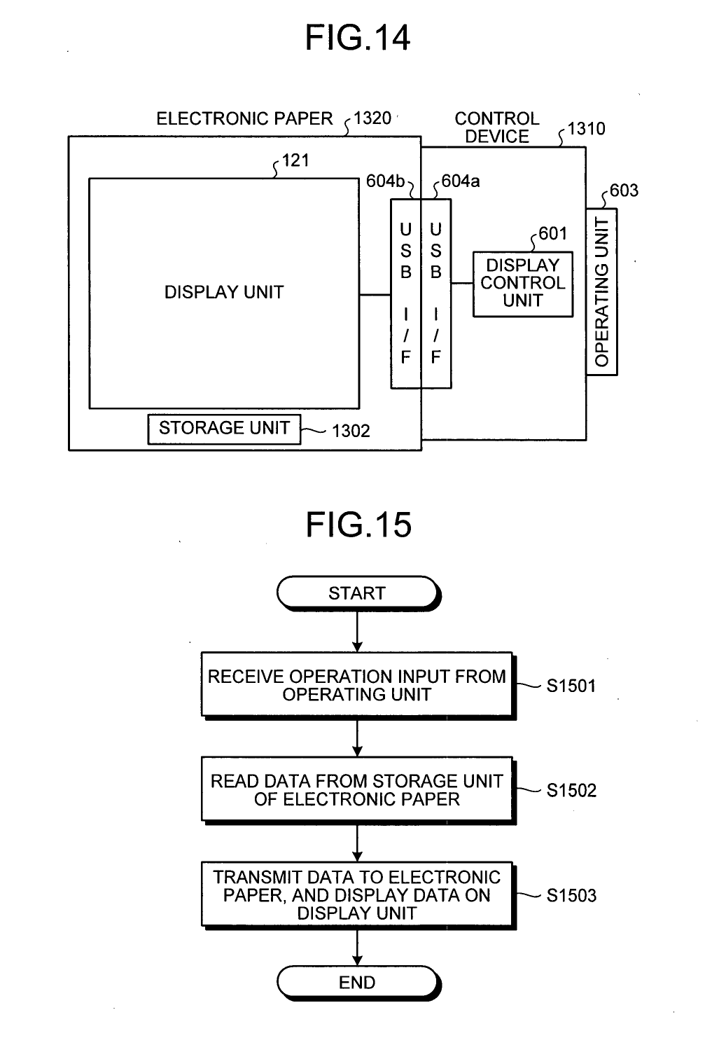

A functional configuration of the electronic paper 1320 and the control device 1310 of the information processing apparatus 1300 according to the second embodiment is explained next. FIG. 14 is a block diagram of a functional configuration of the electronic paper 1320 and the control device 1310 of the information processing apparatus 1300 according to the second embodiment.

The electronic paper 1320 according to the second embodiment includes the display unit 121, the USB I/F 604b, and the storage unit 1302, as shown in FIG. 14. The storage unit 1302 is a storage medium that stores data to be displayed in the display unit 121. The functions of the display unit 121 and the USB I/F 604b are identical to those of the electronic paper 120 according to the first embodiment.

On the other hand, the control device 1310 includes the operating unit 603, the display control unit 601, the USB I/F 604a, and a power supply unit (not shown). The control device 1310 of the second embodiment is different from that of the first embodiment in that the control device 1310 does not include a storage unit. Functions of the operating unit 603, the display control unit 601, the USB I/F 604a, and the power supply unit are identical to those of the first embodiment.

A data display process performed by the information processing apparatus 1300 having the above configuration is explained next. FIG. 15 is a flowchart of a process procedure of displaying the data performed by the information processing apparatus 1300 according to the second embodiment.

First, the control device 1310 receives an operation input carried out by a user from the operating unit 603 (step S1501). The display control unit 601 reads display data from the storage unit 1302 of the electronic paper 1320 via the USB I/Fs 604a and 604b, following the received operation input (step S1502). The display control unit 601 transmits the read display data to the display unit 121 of the electronic paper 1320 via the USB I/Fs 604a and 604b, and displays the data in the display unit 121 (step S1503).

As explained above, the information processing apparatus 1300 according to the second embodiment carries out a display control of reading display data stored in the storage unit 1302 of the electronic paper 1320, and displaying the data in the bendable display unit 121 provided in the electronic paper 132 capable of electrically displaying and erasing the display data, via the USB I/Fs 604a and 604b. Therefore, the information processing apparatus 1300 can instantly deliver data to a third party by holding a large amount of data while maintaining information transmissibility and portability. Further, according to the information processing apparatus 1300 of the second embodiment, the storage unit that stores display data is provided in the electronic paper 1320. Therefore, the electronic paper 132Q holding a large amount of display data can be delivered to a third party, thereby further improving information transmissibility.

The information processing apparatus 1300 according to the second embodiment can be configured to perform transmission/reception of data between the electronic paper 1320 and the control device 1310 using the interface of a radio LAN such as the IEEE 802.11a and the IEEE 802.11b.

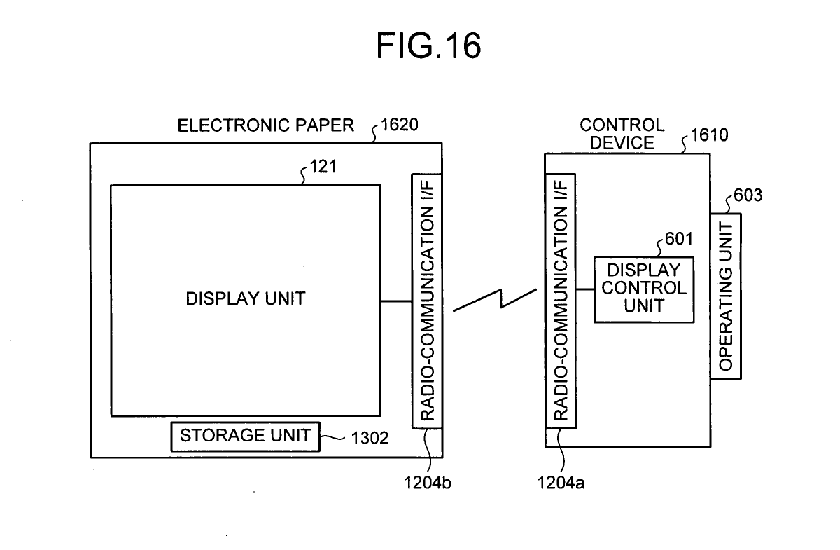

FIG. 16 is a block diagram of a functional configuration of the electronic paper 1320 and the control device 1310 that perform transmission/reception of data between the electronic paper 1320 and the control device 1210 using the interface of a radio LAN. In the example shown in FIG. 16, the radio-communication I/Fs 1204a and 1204b as interfaces of a radio LAN such as the IEEE 802.11a and the IEEE 802.11b are provided in a control device 1610 and electronic paper 1620, respectively, instead of the USB I/F.

While the information processing apparatus 100 according to the first embodiment includes the storage unit in the control device 110, an information processing apparatus according to a third embodiment of the present invention includes a storage unit in electronic paper.

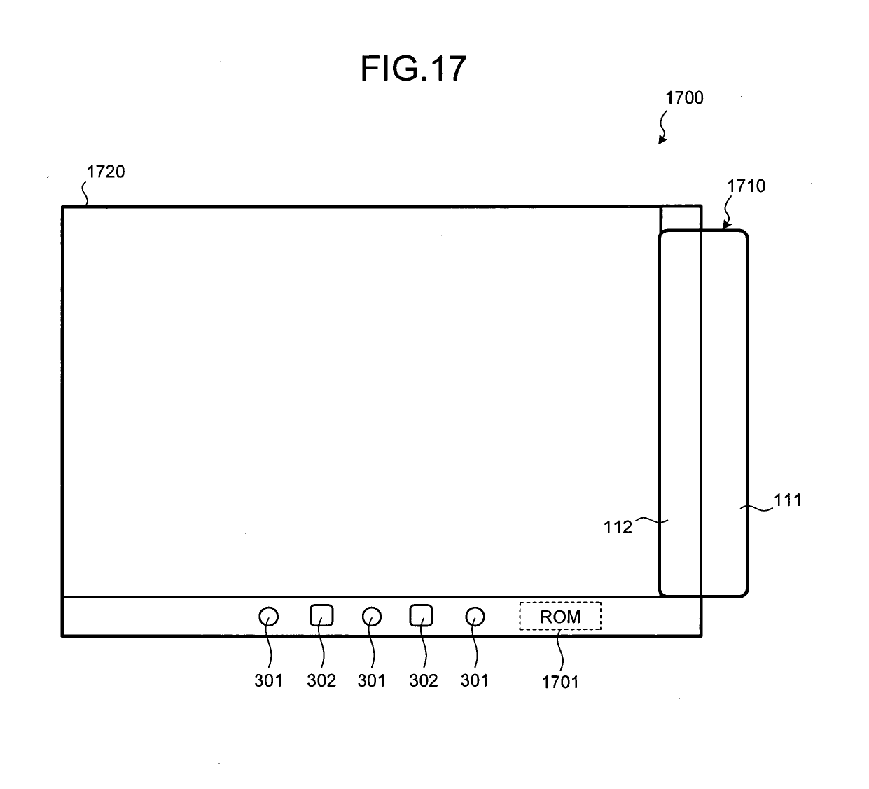

FIG. 17 is a schematic of a configuration of an information processing apparatus 1700 according to the third embodiment. The appearance of the information processing apparatus 1700 according to the third embodiment is identical to the information processing apparatus 100 of the first embodiment.

As shown in FIG. 17, the information processing apparatus 1700 according to the third embodiment includes an electronic paper 1720 and a control device 1710. In the third embodiment, a plate member of the electronic paper 1720 includes a read only memory (ROM) 1701 and a RAM (not shown) incorporated in with a display control program.

The RAM is a memory developed as a display control unit when a display control program incorporated in the ROM is executed.

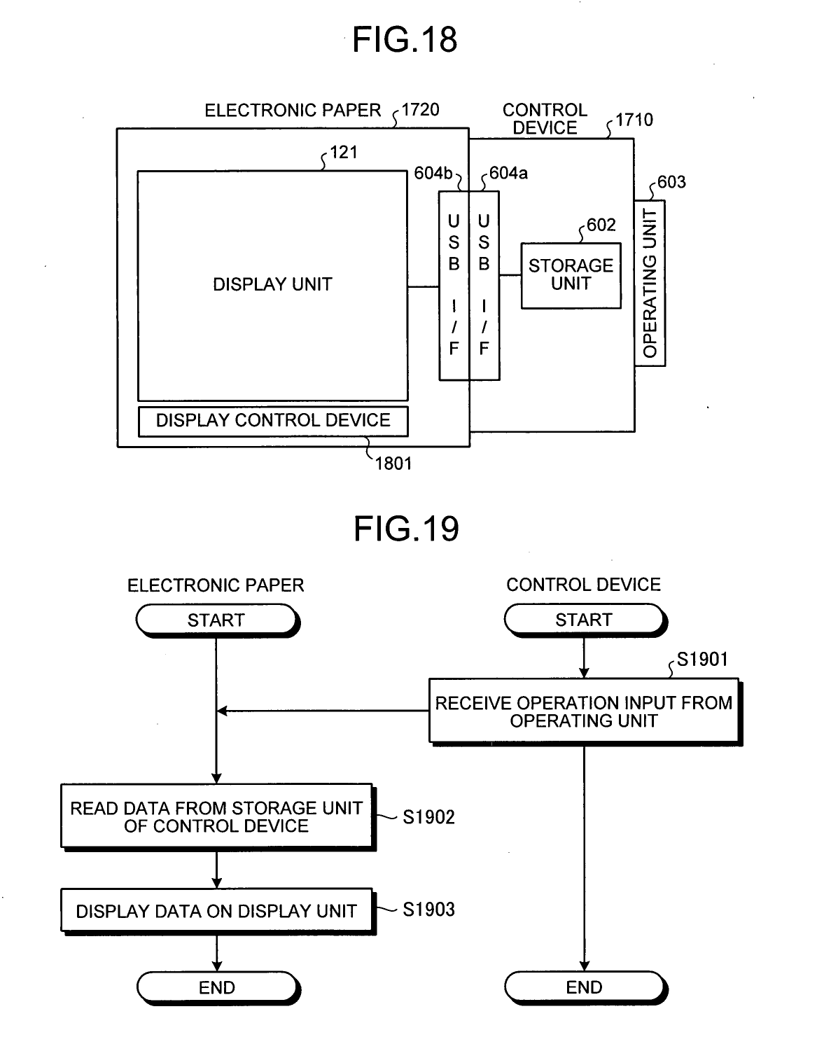

A functional configuration of the electronic paper 1720 and the control device 1710 of the information processing apparatus 1700 according to the third embodiment is explained next. FIG. 18 is a block diagram of a functional configuration of the electronic paper 1720 and the control device 1710 of the information processing apparatus 1700 according to the third embodiment.

The electronic paper 1720 according to the third embodiment includes the display unit 121, the USB I/F 604b, and a display control unit 1801. FIG. 18 depicts a state that a display control program stored in the ROM 1701 is executed and is developed into the RAM (not shown), and the RAM operates as the display control unit 1801.

The display control unit 1801 controls the display unit 121 that displays data stored in the control device 1710. The functions of the display unit 121 and the USB I/F 604b are identical to those of the electronic paper 120 according to the first embodiment.

On the other hand, the control device 1710 includes the operating unit 603, the storage unit 602, the USB I/F 604a, and a power supply unit (not shown). The control device 1710 of the third embodiment is different from that of the first embodiment in that the control device 1710 does not include a display control unit. Functions of the operating unit 603, the storage unit 602, the USB I/F 604a, and the power supply unit are identical to those of the first embodiment.

A data display process performed by the information processing apparatus 1700 having the above configuration is explained next. FIG. 19 is a flowchart of a process procedure of displaying the data performed by the information processing apparatus 1700 according to the third embodiment.

First, the control device 1710 receives an operation input carried out by a user from the operating unit 603, and transmits the received operation input to the electronic paper 1720 via the USB I/F 604b (step S1901). The electronic paper 1720 receives the operation input via the USB I/F 604b. The display control unit 1801 reads display data from the storage unit 602 of the control device 1710 via the USB I/Fs 604a and 604b, following the received operation input (step S1902). The display control unit 1801 of the electronic paper 1720 transmits the read display data to the display unit 121, and the display unit displays the data (step S1903).

As explained above, according to the information processing apparatus 1700 of the third embodiment, the display control unit 1801 of the electronic paper 1720 carries out a display control of reading display data stored in the storage unit 602 of the control device 1710 via the USB I/Fs 604a and 604b, and displaying the data in the bendable display unit 121 provided in the electronic paper 1720 capable of electrically displaying and erasing the display data. Therefore, the information processing apparatus 1700 can instantly deliver data to a third party by holding a large amount of data while maintaining information transmissibility and portability. According to the information processing apparatus 1700 of the third embodiment, the display control unit is provided in the electronic paper 1720. Therefore, the display control unit can have versatility, using a storage medium such as a USB memory as a control device.

The information processing apparatus 1700 according to the third embodiment can be configured to perform transmission/reception of data between the electronic paper 1720 and the control device 1710 using the interface of a radio LAN such as the IEEE 802.11a and the IEEE 802.11b.

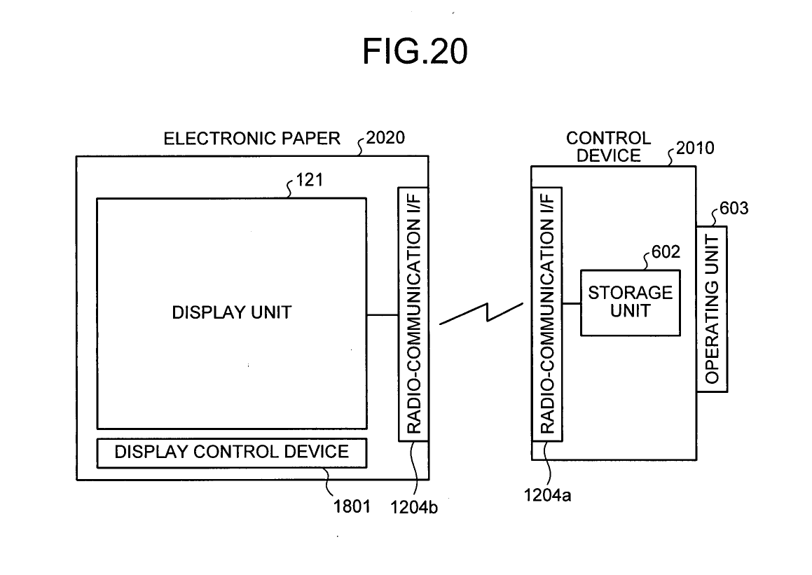

FIG. 20 is a block diagram of a functional configuration of an electronic paper 2020 and a control device 2010 that perform transmission/reception of data between the electronic paper 2020 and the control device 2010 using the interface of a radio LAN. In the example shown in FIG. 20, the radio-communication I/Fs 1204a and 1204b as interfaces of a radio LAN such as the IEEE 802.11a and the IEEE 802.11b are provided in the control device 2010 and the electronic paper 2020, respectively, instead of the USB I/F.

While each of the information processing apparatuses according to the first to third embodiments includes electronic paper and a control device, an information processing apparatus according to a fourth embodiment of the present invention includes only electronic paper as a single unit.

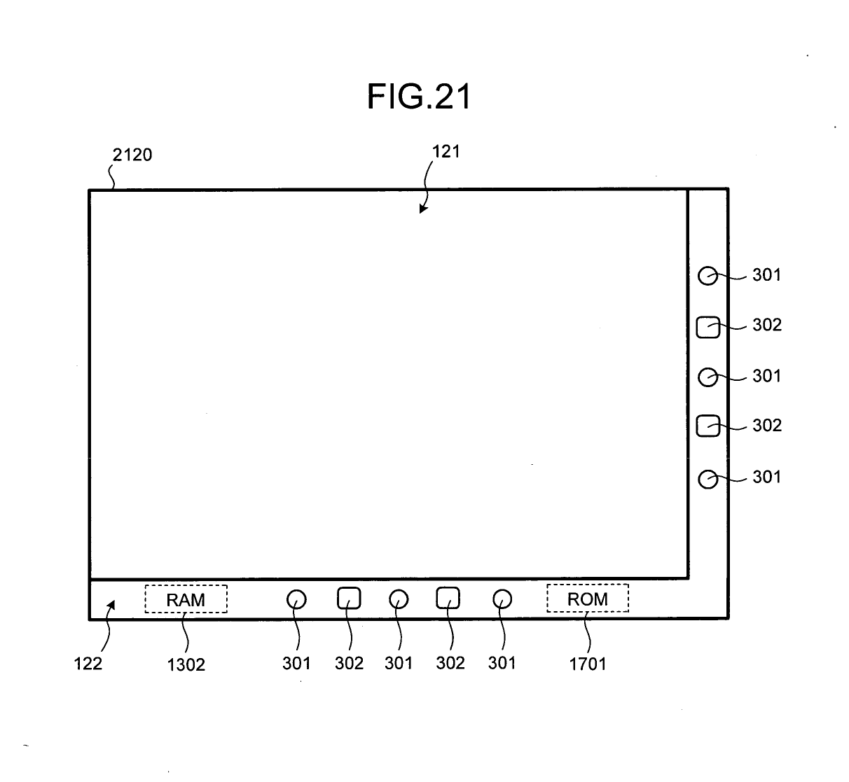

FIG. 21 is a schematic of a configuration of an electronic paper 2120. The display unit 121 of the electronic paper 2120 is mounted on the flexible plate member 122, and is formed using a bendable material together with the plate member 122. The display unit 121 displays and erases display data.

The electronic paper 2120 according to the fourth embodiment includes the ROM 1701 and the RAM 1302 in which a display control program of the plate member 122 is incorporated. The RAM 1302 is a memory as a storage unit in which a display control program incorporated in the ROM is developed as a display control unit when the display control program is executed, and stores display data. Other schematic configurations of the electronic paper 2120 are identical to that of the electronic paper 120 according to the first embodiment explained with reference to FIG. 3.

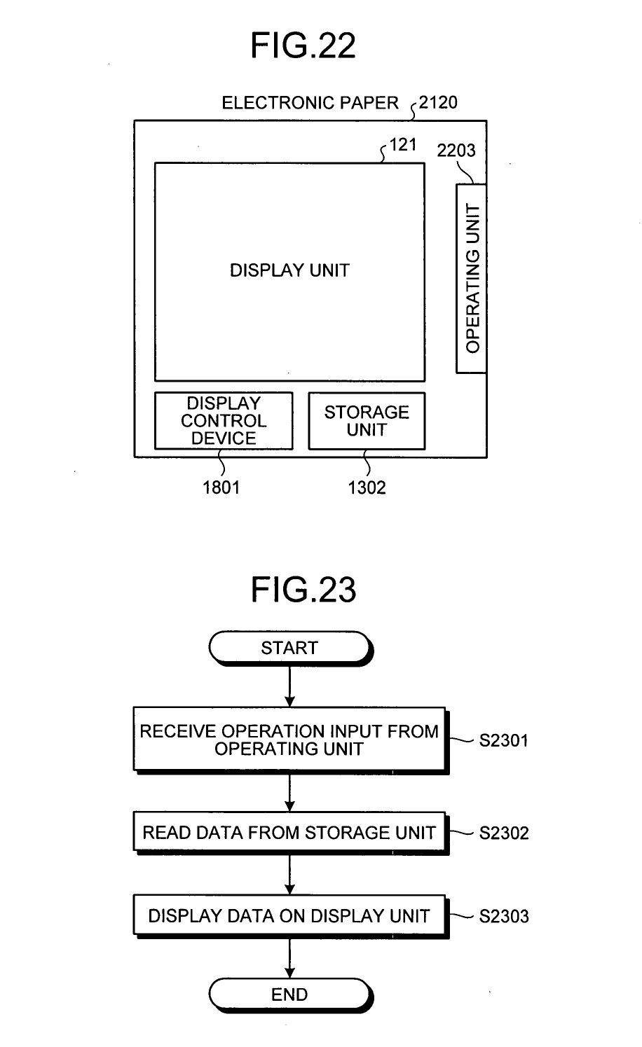

A functional configuration of the electronic paper 2120 according to the fourth embodiment is explained next. FIG. 22 is a block diagram of the functional configuration of the electronic paper 2120 according to the fourth embodiment.

As shown in FIG. 22, the electronic paper 2120 according to the fourth embodiment includes the display unit 121, the display control unit 1801, the storage unit (RAM) 1302, an operating unit 2203, and a power supply unit (not shown). FIG. 22 depicts a state that a display control program stored in the ROM 1701 is executed and is developed in the storage unit (RAM), and functions as the display control unit 1801.

The storage unit 1302 is a memory that stores data to be displayed. The operating unit 2203 receives the operation input from a user. The display control unit 1801 carries out a display control to the display unit 121 of display data stored in the storage unit 1302 according to the operation input from the operating unit 2203.

A display process of displaying data performed by the electronic paper 2120 having the above configuration is explained next. FIG. 23 is a flowchart of a process procedure of displaying data performed by the electronic paper 2120 according to the fourth embodiment.

First, the electronic paper 2120 receives an operation input from a user (step S2301). Next, the display control unit 1801 reads display data from the storage unit 1302, following the received operation input (step S2302). The display control unit 1801 transmits the read display data to the display unit 121, and the display unit displays the data (step S2303).

As explained above, according to the electronic paper 2120 of the fourth embodiment, the display control unit 1801 of the electronic paper 2120 carries out a display control of reading display data stored in the storage unit 1302, and displaying the data in the bendable display unit 121 capable of electrically displaying and erasing the display data. Therefore, the electronic paper 2120 can instantly deliver data to a third party by holding a large amount of data while maintaining information transmissibility and portability. According to the electronic paper 2120 of the fourth embodiment, the display unit, the display control unit, and the storage unit are provided in the electronic paper 2120. Therefore, the electronic paper 2120 including the display data can be delivered straight to a third party in a displayable state, thereby improving information transmissibility.

According to the first to the fourth embodiments, constituent elements and operations of the information processing apparatus including electronic paper and a control device have been explained. In the following fifth to eighth embodiments of the present invention, configurations of an information processing apparatus including electronic paper and a control device that operates in collaboration with an MFP is explained in detail.

The control device according to the first and second embodiments, and the electronic paper according to the third and fourth embodiments include a central processing unit (CPU), a ROM, and a RAM.

A display control program that is executed by the control device according to the first and second embodiments and the electronic paper according to the third and fourth embodiments is incorporated in the ROM in advance.

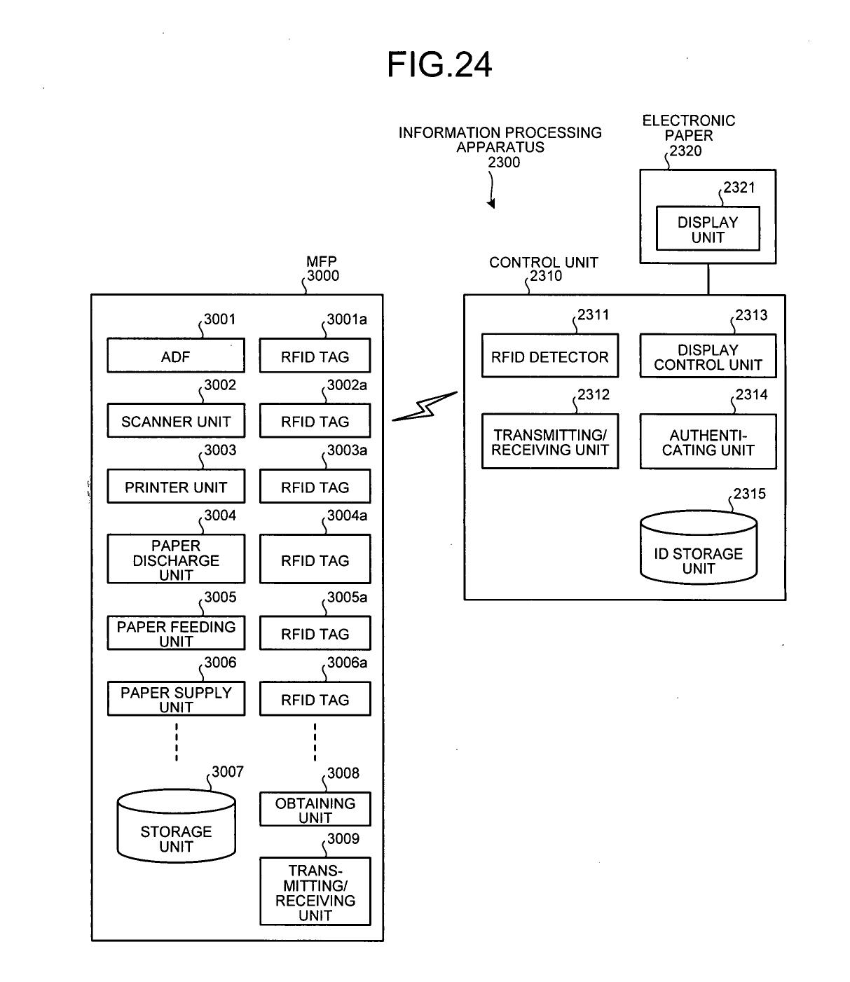

A display processing system according to the fifth embodiment includes an image processing device and an information processing apparatus. When the image processing apparatus is brought close to a constituent element of the image processing apparatus of an MFP, the information processing apparatus receives and displays information of a manual of the contacted constituent element. FIG. 24 is a block diagram of a configuration of the display processing system according to the fifth embodiment. As shown in FIG. 24, the display processing system according to the fifth embodiment includes an MFP 3000 and an information processing apparatus 2300. The MFP 3000 and the information processing apparatus 2300 are connected to each other via a radio communication network such as a radio LAN. In the fifth embodiment, the image processing apparatus of the present invention is applied to an MFP that accommodates plural functions of a scanner, a copying machine, a facsimile machine, and a printer into one casing.

Details of the MFP 3000 are explained first. The MFP 3000 scans a document, and generates and prints image data of the scanned document. The MFP 3000 includes an automatic document feeder (ADF) 3001, a scanner unit 3002, a printer unit 3003, a paper discharge unit 3004, a paper feeding unit 3005, a paper supply unit 3006, radio-frequency Identification (RFID) tags 3001a to 3006a, a storage unit 3007, an obtaining unit 3008, and a transmitting/receiving unit 3009.

The ADF 3001 continuously feeds plural pieces of documents mounted by a user at a constant position, to a document table, and discharges the documents after the documents are processed by the scanner unit 3002 described later.

The scanner unit 3002 scans and reads a document mounted by a user or a document sent by the ADF 3001, with a charge-coupled device (CCD).

The printer unit 3003 prints image data generated from a document scanned by the scanner unit 3002, onto a paper medium or the like.

The paper discharge unit 3004 discharges a paper medium printed by the printer unit 3003, from the body inside of the MFP 3000.

The paper feeding unit 3005 conveys a paper medium or the like from the paper supply unit 3006 to the printer unit 3003 and the paper discharge unit 3004, inside the body of the MFP 3000.

The paper supply unit 3006 is a paper supply cassette that accommodates a paper medium on which data is to be printed by the printer unit 3003.

The RFID tags 3001a to 3006a (information recording mediums) are provided near the constituent elements corresponding to these constituent elements such as the ADF 3001, the scanner unit 3002, the printer unit 3003, the paper discharge unit 3004, the paper feeding unit 3005, and the paper supply unit 3006. The RFID tags 3001a to 3006a include IC chips and antennas including a memory and a transmitting/receiving unit (not shown). The RFID tags 3001a to 3006a are passive RFID tags that transmit IDs of constituent elements to the information processing apparatus 2300, when the memory stores IDs of constituent elements as identification information own to each constituent element such as the ADF 3001, for example, and when the transmitting/receiving unit receives a signal from the information processing apparatus 2300 within a predetermined range via the antenna. The RFID reads and writes IDs in non-contact, using waves and electromagnetic waves. A tag having electronic information within the RFID exchanges information with a reading device (an RFID detector) using waves and electromagnetic waves, thereby identifying the information recorded on the tag.

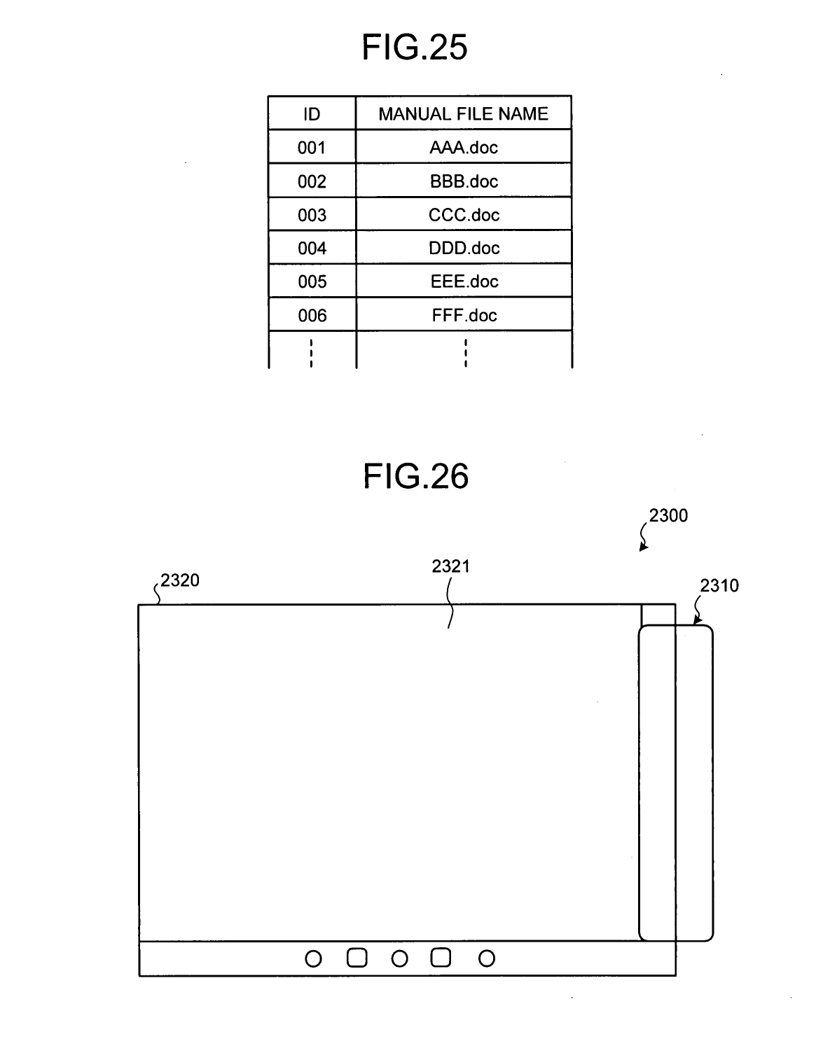

The storage unit 3007 stores data (relevant information) of a manual that explains a constituent element of the MFP 3000. The storage unit 3007 stores manual data corresponding to the ADF 3001, manual data corresponding to the scanner unit 3002, and manual data corresponding to each constituent element. The manual data describes explanations of the functions of the constituent elements, operating methods, and countermeasures against troubles. The storage unit 3007 stores a correspondence table having the IDs of the constituent elements corresponded to manual file names (relevant identification information) of the constituent elements. FIG. 25 is one example of a correspondence table stored in the storage unit 3007. As shown in FIG. 25, the correspondence table stores IDs (001, 002, etc.) of the constituent elements, and their manual file names (AAA.doc, BBB.doc, etc.) by relating them to each other.

The transmitting/receiving unit 3009 receives, from the information processing apparatus 2300, a message that the information processing apparatus 2300 has authenticated IDs of the constituent elements transmitted from the RFID tags 3001a to 3006a to the information processing apparatus 2300 and that the authentication has been successful. The transmitting/receiving unit 3009 also transmits manual data obtained by the obtaining unit 3008 explained later to the information processing apparatus 2300. For example, the transmitting/receiving unit 3009 carries out communication following the communication protocol of the radio LAN such as the IEEE 802.11. The transmitting/receiving unit 3009 can use any communication protocol capable of transmitting and receiving manual data, instead of the above communication protocol.

When the transmitting/receiving unit 3009 receives from the information processing apparatus 2300 that IDs of the constituent elements transmitted from the RFID tags have been successfully authenticated, the obtaining unit 3008 obtains manual data shown by the manual file names corresponding to the IDs of the constituent elements that have been successfully authenticated, from the storage unit 3007, using the IDs of the constituent elements that have been successfully authenticated.

Details of the information processing apparatus 2300 are explained next. The information processing apparatus 2300 has a size and weight in which the user can easily carry this apparatus. The information processing apparatus 2300 displays information received from the MFP 3000. FIG. 26 is a schematic of a configuration of the information processing apparatus 2300. As shown in FIG. 26, the information processing apparatus 2300 includes an electronic paper 2320 having a display unit 2321, and a control unit 2310.

The display unit 2321 has a thickness of about a few tenths of millimeters that can display and erase data by an electric method. The electronic paper 2320 is a reflection type display medium that is expected to achieve “coupling and rewritability of digital information” held by softcopy copied on a screen of the display unit and paper resource saving, in addition to “easiness of reading and carrying” held by hardcopy printed on a paper medium. In this way, the electronic paper 2320 has characteristics of ultra-thinness and flexibility that are not possible to the conventional image information processing apparatus.

The control unit 2310 includes an ID storage unit 2315, an RFID detector 2311, an authenticating unit 2314, a transmitting/receiving unit 2312, and a display control unit 2313.

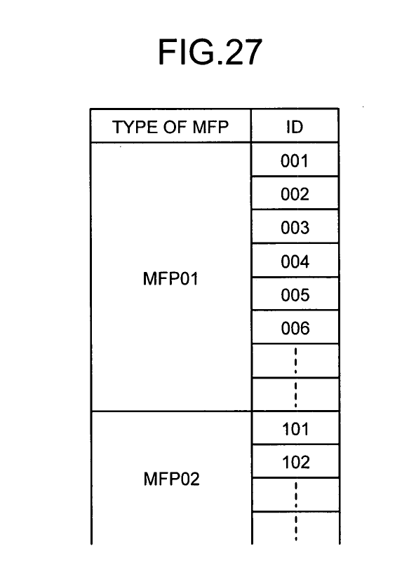

The ID storage unit 2315 stores types of MFPs and IDs of constituent elements by relating the types and the IDs to each other. FIG. 27 is one example of a table stored in the ID storage unit 2315. As shown in FIG. 27, the table stored in the ID storage unit 2315 stores types of MFPs (MFP01, MFP02) and IDs (001, 002) of the constituent elements of the MFP 3000, by relating the types and the IDs to each other.

The RFID detector 2311 detects IDs of constituent elements transmitted from the RFID tags 3001a to 3006a positioned within a predetermined range from the information processing apparatus 2300, by bringing the information processing apparatus 2300 to the RFID tags 3001a to 3006a that hold the IDs of the constituent elements provided near the constituent elements of the MFP 3000. In other words, the RFID detector 2311 transmits signals to the RFID tags 3001a to 3006a within a communication range. When the IDs of the constituent elements are transmitted from the RFID tags 3001a to 3006a that receive the signals, the RFID detector 2311 detects the transmitted IDs of the constituent elements in non-contact. In the fifth embodiment, the RFID detector 2311 detects the IDs of the constituent elements in non-contact, by bringing the information processing apparatus 2300 close to the RFID tags 3001a to 3006a. Alternatively, the RFID detector 2311 can be configured to detect IDs of the constituent elements in contact, by bringing the information processing apparatus 2300 into contact with the RFID tags 3001a to 3006a. The RFID detector 2311 can be also configured to detect IDs of the constituent elements from the active RFID tags 3001a to 3006a that are transmitted at a constant interval, when the information processing apparatus 2300 is brought close to within a communication range of the RFID tags 3001a to 3006a.

Upon detecting IDs of the constituent elements transmitted from the RFID tags 3001a to 3006a by the RFID detector 2311, the authenticating unit 2314 refers to the ID storage unit 2315, and authenticates the storage of the IDs of the constituent elements detected corresponding to types of the MFP 3000 that transmits the IDs of the constituent elements, using the detected IDs of the constituent elements.

When the authenticating unit 2314 has been successful in authenticating the IDs of the constituent elements, the transmitting/receiving unit 2312 transmits this fact to the MFP 3000. The transmitting/receiving unit 2312 receives the manual data of the constituent elements from the MFP 3000 that has obtained this manual data and has received the fact that the authenticating unit 2314 has been successful in authenticating the IDs of the constituent elements.

The display control unit 2313 controls the display of the manual data received by the transmitting/receiving unit 2312, in the display unit 2321 of the electronic paper 2320.

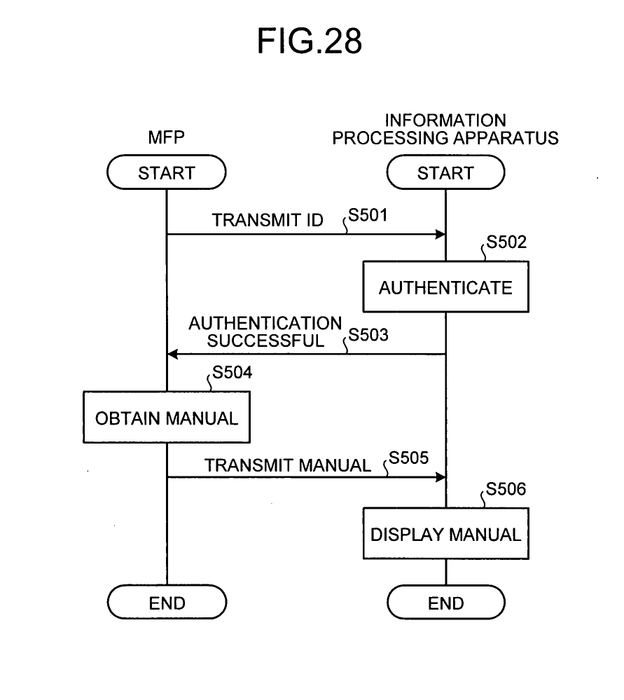

A display process performed by the display processing system having the above configuration is explained next. FIG. 28 is a sequence diagram of a display process procedure performed by the display processing system according to the fifth embodiment.

When a user brings the information processing apparatus 2300 close to a constituent element of the MFP 3000 of which manual the user wishes to display, the information processing apparatus 2300 is brought close to a RFID tag provided near this constituent element. When the information processing apparatus 2300 transmits a signal to the RFID tag within a range of a communication distance, the RFID tag that receives this signal transmits an ID of the constituent element to the information processing apparatus 2300 (step S501). The RFID detector 2311 of the information processing apparatus 2300 detects the ID of the constituent element transmitted from the RFID tag. The authenticating unit 2314 refers to the ID storage unit 2315, and authenticates the storage of the ID of the constituent element, corresponding to a type of the MFP 3000 that transmits the ID of the constituent element (step S502).

When the authenticating unit 2314 has been successful in authenticating the ID of the constituent element, the transmitting/receiving unit 2312 of the information processing apparatus 2300 transmits this fact to the MFP 3000 (step S503), and the transmitting/receiving unit 3009 of the MFP 3000 receives this message. When the transmitting/receiving unit 3009 receives a message that the ID of the constituent element has been successful, the obtaining unit 3008 obtains manual data of the constituent element corresponding to the ID of the constituent element from the storage unit 3007 (step S504).

The transmitting/receiving unit 3009 transmits the manual data of the constituent element obtained by the obtaining unit 3008, to the information processing apparatus 2300 (step S505), and the transmitting/receiving unit 2312 of the information processing apparatus 2300 receives the manual data. The display control unit 2313 displays the manual data received by the transmitting/receiving unit 2312, in the display unit 2321 of the electronic paper 2320 (step S506).

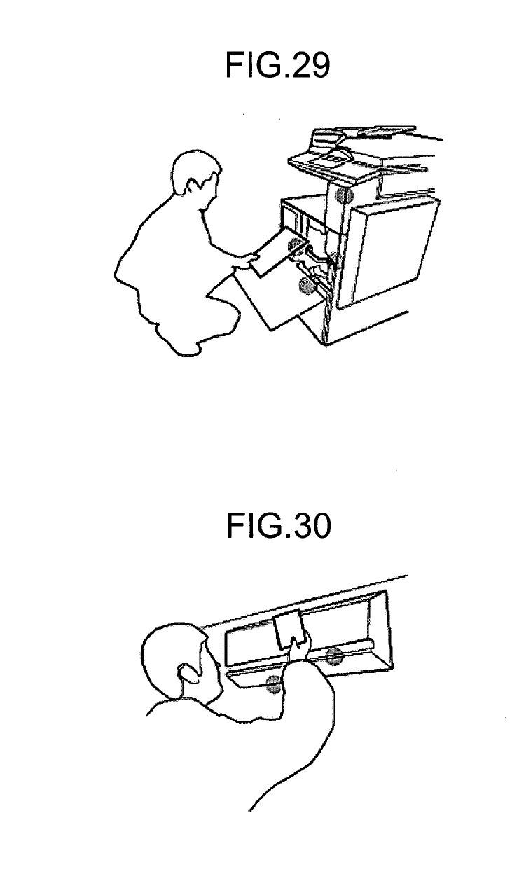

An example of the use of the display processing system according to the fifth embodiment is explained next. FIG. 29 depicts a using state of the display processing system according to the fifth embodiment. FIG. 29 depicts a state that a user is bringing the information processing apparatus 2300 to the constituent element of the MFP 3000 that the user wishes to display. As shown in FIG. 29, the user opens the cover of the MFP 3000, and brings the information processing apparatus 2300 close to the constituent element. The manual data of the constituent element is then displayed in the information processing apparatus 2300. Specifically, when the user wishes to read a manual of the ADF 3001, for example, the user brings the information processing apparatus 2300 to the ADF 3001, thereby bringing the information processing apparatus 2300 close to the RFID tag 3001a provided near the ADF 3001. As a result, the manual data of the ADF 3001 is displayed in the information processing apparatus 2300. The user can read the manual of the ADF 3001, without searching the manual.

As explained above, according to the display processing system of the fifth embodiment, when a user brings the portable information processing apparatus 2300 close to a constituent element of the MFP 3000, the information processing apparatus 2300 receives an ID of the constituent element from the corresponding one of the RFID tags 3001a to 3006a provided near the constituent element. When the information processing apparatus 2300 has been successful in authenticating the received ID of the constituent element, the information processing apparatus 2300 transmits this fact to the MFP 3000. The obtaining unit of the MFP 3000 receives the manual data of the constituent element, and displays the received manual data in the display unit 2321. With this arrangement, when the user brings the information processing apparatus 2300 close to the constituent element of which information is to be displayed, the user can obtain the manual data of the desired constituent element without searching. When the thin and light electronic paper 2320 of which displayed characters can be easily recognized is used for the information processing apparatus 2300, the user can carry this apparatus instantly. Because the displayed characters can be easily recognized, even elderly people or people having weak eyesight can easily use this apparatus.

Furthermore, the display processing system according to the fifth embodiment can be also applied to an air conditioning apparatus such as a room cooler. In this case, RFID tags are provided near the constituent elements of the air conditioning apparatus. When the information processing apparatus is brought close to a constituent element of which information is to be displayed, information of the manual of the constituent element can be displayed in the information processing apparatus. FIG. 30 depicts a using state when the display processing system according to the fifth embodiment is applied to the air conditioning apparatus. FIG. 30 depicts a state that a user brings the information processing apparatus close to a constituent element of the air conditioning apparatus of which information is to be displayed. Based on this operation, an explanation of a function of the air conditioning apparatus, an operating method, and countermeasures against troubles are displayed in the information processing apparatus.

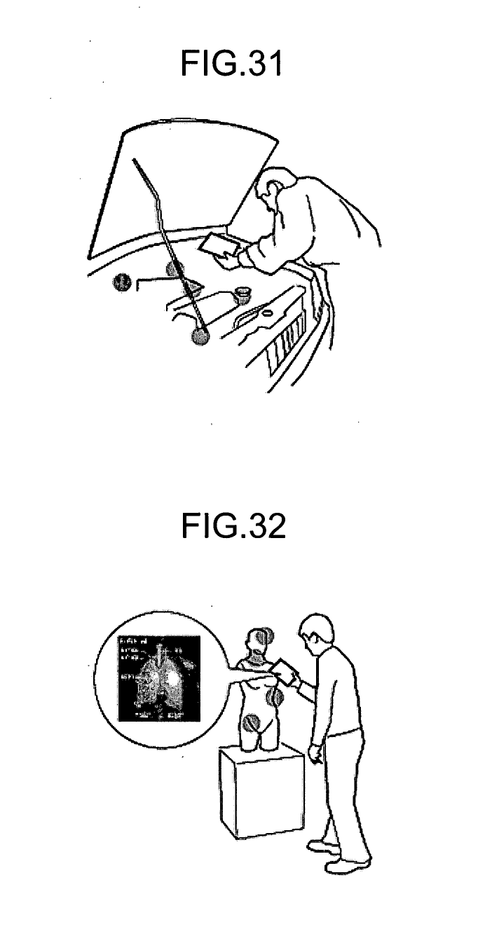

Furthermore, the display processing system according to the fifth embodiment can be also applied to vehicle such as an automobile. In this case, RFID tags storing record information such as a replacement time of a constituent element and mileage are provided near the constituent elements of the automobile such as an engine and a battery, in a similar manner to that applied to the MFP. When the information processing apparatus is brought close to a constituent element of which record information is to be displayed, the record information of this constituent element is displayed. FIG. 31 depicts a using state of the display processing system according to the fifth embodiment when this system is applied to an automobile. FIG. 31 depicts a state that a user brings the information processing apparatus close to constituent elements of the automobile of which record information is to be displayed. Based on this operation, record information such as a replacement time of constituent elements and mileage of the automobile can be displayed in the information processing apparatus.

Moreover, the display processing system according to the fifth embodiment can be also applied to a teaching material of a model of a human body. In this case, RFID tags are provided near constituent elements of a model of a human body such as a breast and a head of the model, in a similar manner to that applied to the MFP. When the information processing apparatus is brought close to a constituent element of which information is to be displayed, the information of the constituent element is displayed in the information processing apparatus. FIG. 32 depicts a using state when the display processing system according to the fifth embodiment is applied to the model of a human body. FIG. 32 depicts a state that the user brings the information processing apparatus close to a constituent element of the model of a human body of which information the user wishes to display. Based on this operation, information such as a drawing and an explanation about the inside of a human body is displayed in the information processing apparatus, from the constituent element of the model of a human body close to which the information processing apparatus is brought.

According to the display processing system of the fifth embodiment, a user brings the information processing apparatus close to a constituent element of the information processing apparatus. Based on this operation, the information processing apparatus receives information of the constituent element stored in the image processing apparatus, and displays this information. However, according to a display processing system of the sixth embodiment, the information processing apparatus is brought close to a constituent element of the image processing apparatus. Based on this operation, the information processing apparatus receives identification information of the constituent element, and displays the information of the constituent element stored in the information processing apparatus.

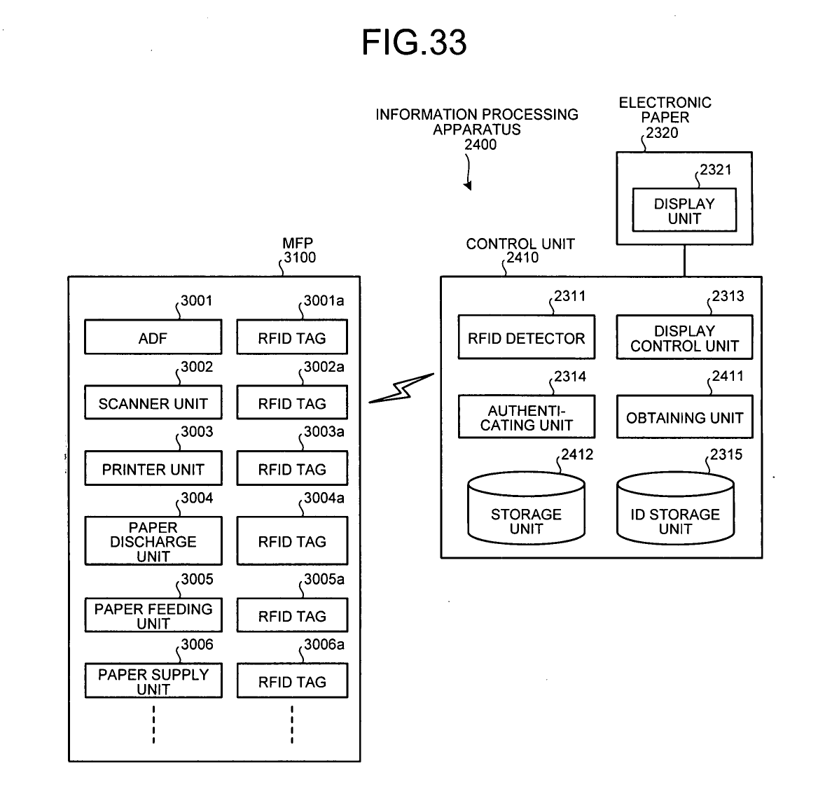

FIG. 33 is a block diagram of a configuration of the display processing system according to the sixth embodiment.

As shown in FIG. 33, the display processing system according to the sixth embodiment includes an MFP 3100 and an information processing apparatus 2400. In the sixth embodiment, the image processing apparatus of the present invention is applied to an MFP, in a similar manner to that applied to the fifth embodiment.

Details of the MFP 3100 are explained first. The MFP 3100 scans a document, and generates and prints image data of the scanned document. The MFP 3100 includes the ADF 3001, the scanner unit 3002, the printer unit 3003, the paper discharge unit 3004, the paper feeding unit 3005, the paper supply unit 3006, and the RFID tags 3001a to 3006a. Unlike the MFP 3000 according to the fifth embodiment, the MFP 3100 according to the sixth embodiment does not include the storage unit 3007, the obtaining unit 3008, and the transmitting/receiving unit 3009. Configurations and functions of the ADF 3001, the scanner unit 3002, the printer unit 3003, the paper discharge unit 3004, the paper feeding unit 3005, and the paper supply unit 3006 are identical to those of the fifth embodiment, and therefore redundant explanations will be omitted.

Details of the information processing apparatus 2400 are explained next. The information processing apparatus 2400 has a size and weight in which the user can easily carry the apparatus. The information processing apparatus 2400 displays information stored in the information processing apparatus 2400. The information processing apparatus 2400 mainly includes the electronic paper 2320 having the display unit 2321 and a control unit 2410, like in the fifth embodiment. Configurations and functions of the electronic paper 2320 having the display unit 2321 are identical to those of the fifth embodiment, and therefore redundant explanations will be omitted.

The control unit 2410 includes the ID storage unit 2315, a storage unit 2412, the RFID detector 2311, the authenticating unit 2314, an obtaining unit 2411, and the display control unit 2313. The ID storage unit 2315, the RFID detector 2311, and the authenticating unit 2314 are identical to those of the fifth embodiment, and therefore redundant explanations will be omitted.

The storage unit 2412 stores data of a manual that explains a constituent element of the MFP 3100. In other words, the storage unit 2412 stores manual data of constituent elements such as manual data of the ADF 3001, manual data of the scanner unit 3002, or the like. This manual data describes an explanation and a method of operating each constituent element, and countermeasures against troubles. The storage unit 2412 also stores a table relating to types of MFPS, IDs of the constituent elements, and manual names of the constituent elements.

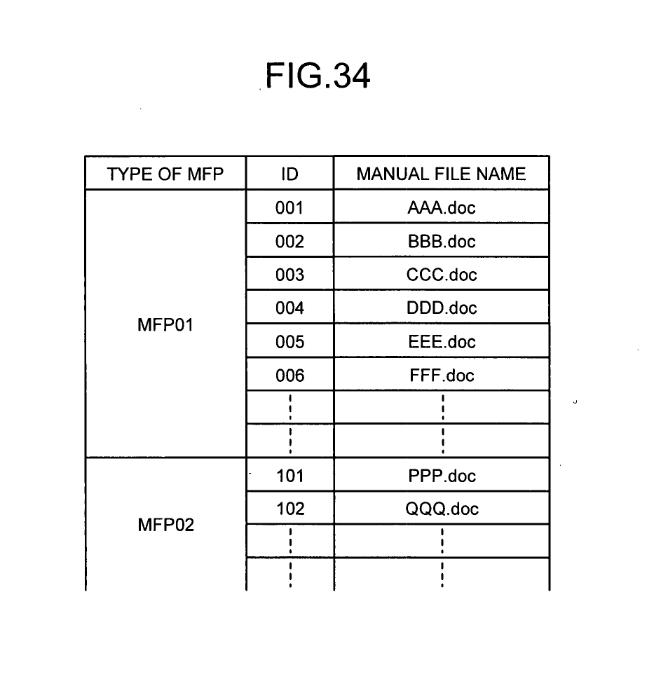

FIG. 34 is one example of a correspondence table stored in the storage unit. As shown in FIG. 34, the correspondence table stores types of MFPs (MFP01, MFPO2), IDs of the constituent elements (001, 002, etc.), and manual file names (AAA.doc, BBB.doc, etc.) by relating them to each other.

When the authenticating unit 2314 has successfully authenticated an ID of a constituent element transmitted from an RFID tag, the obtaining unit 2411 obtains manual data shown by a manual file name corresponding to the ID of the constituent element that has been successfully authenticated, from the storage unit 2412, using the ID of the constituent element that has been successfully authenticated.

The display control unit 2313 controls the display of manual data obtained by the obtaining unit 2411, in the display unit 2321 of the electronic paper 2320.

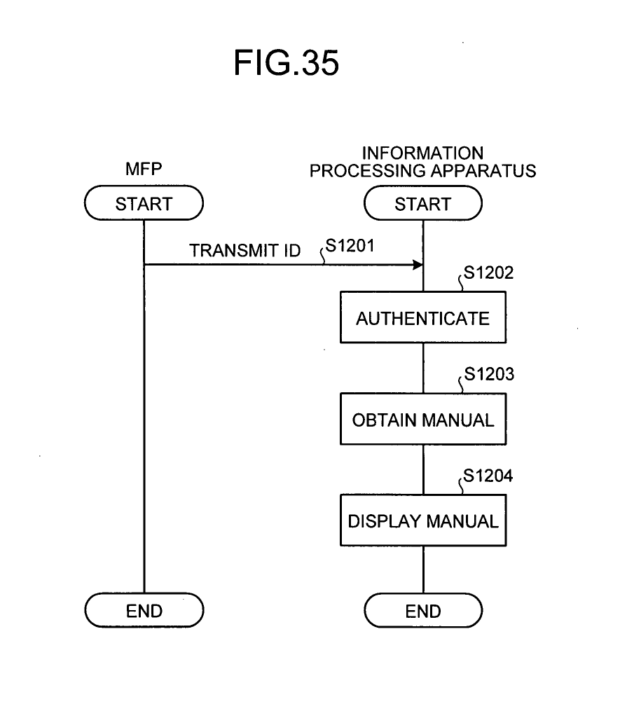

A display process performed by the display processing system having the above configuration is explained next. FIG. 35 is a sequence diagram of a display process procedure performed by the display processing system according to the sixth embodiment.

The process from the transmission of an ID of a constituent element according to an RFID tag to the authentication carried out by the authenticating unit 2314 (steps S1201, S1202) is similar to the corresponding process according to the fifth embodiment (steps S501, S502). Therefore, explanations of the above process will be omitted.

When the authenticating unit 2314 has been successful in authenticating the ID of the constituent element, the obtaining unit 2411 of the information processing apparatus 2400 obtains manual data of the constituent element corresponding to the ID of the constituent element from the storage unit 2412 (step S1203).

The display control unit 2313 displays the manual data obtained by the obtaining unit 2411, in the display unit 2321 of the electronic paper 2320 (step S1204).

As explained above, according to the display processing system of the sixth embodiment, when the portable information processing apparatus 2400 is brought close to a constituent element of the MFP 3100, the information processing apparatus 2400 receives an ID of the corresponding one of the constituent elements of the RFID tags 3001a to 3006a provided near the constituent element. When the information processing apparatus has been successful in authenticating the received ID of the constituent element, the apparatus displays the manual data of the constituent element stored in the storage unit 2412. With this arrangement, a user can obtain the manual data of the constituent element that the user wishes to read without searching the manual data, by only bringing the information processing apparatus 2400 close to the constituent element of which manual data is to be displayed. When the thin and light electronic paper 2320 of which displayed characters can be easily recognized is used for the information processing apparatus 2400, the user can carry this apparatus instantly. Because the displayed characters can be easily recognized, even elderly people or people having weak eyesight can easily use this apparatus.

According to the display processing system of the fifth embodiment, a user brings the information processing apparatus close to constituent elements of the information processing apparatus. Based on this operation, the information processing apparatus receives information of the constituent element stored in the image processing apparatus, and displays this information. However, according to a display processing system of a seventh embodiment, the information processing apparatus is brought close to a constituent element of the image processing apparatus. Based on this operation, the information processing apparatus receives identification information of the constituent element, and displays the information of the constituent element stored in a server.

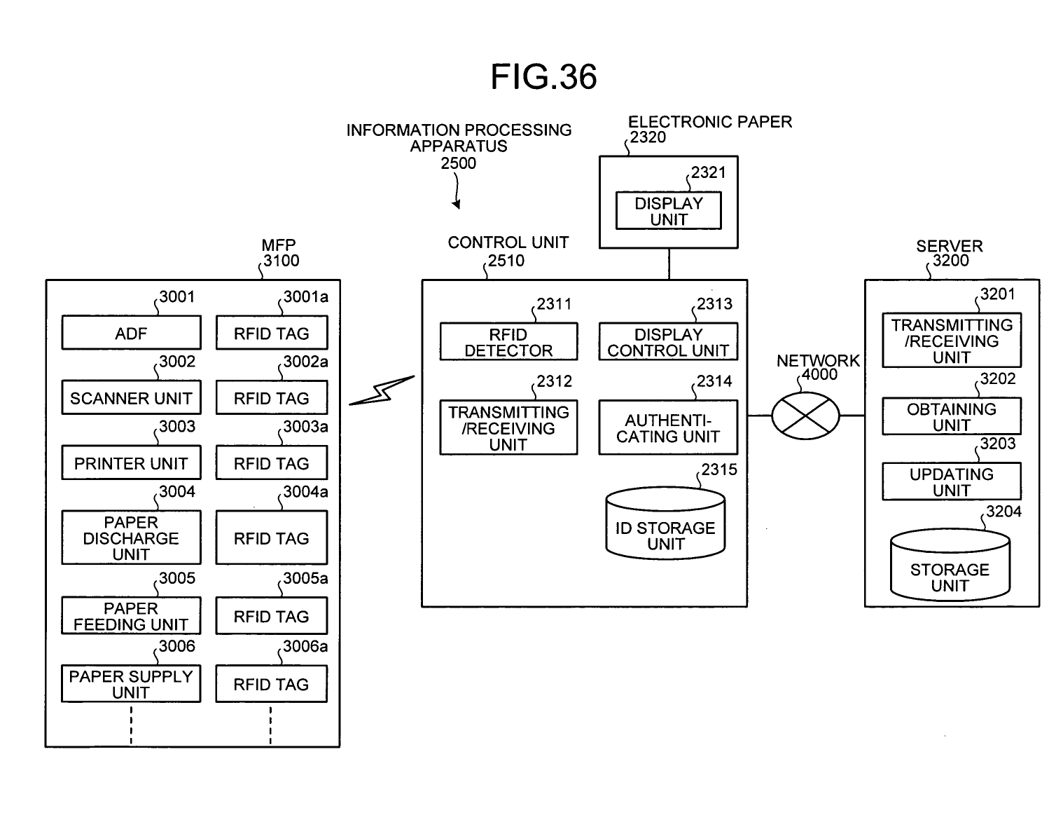

FIG. 36 is a block diagram of a configuration of the display processing system according to the seventh embodiment. As shown in FIG. 36, the display processing system according to the seventh embodiment includes the MFP 3100, an information processing apparatus 2500, and a server 3200. The information processing apparatus 2500 and the server 3200 are connected to a network 4000 such as a telephone line, a radio network, and the Internet. In the seventh embodiment, the image processing apparatus of the present invention is applied to an MFP, in a similar manner to that applied to the fifth embodiment.

Detailed configurations and functions of the MFP 3100 are identical to those of the MFP according to the fifth embodiment, and therefore redundant explanations will be omitted.

Details of the information processing apparatus 2500 are explained next. The information processing apparatus 2500 has a size and weight in which the user can easily carry the apparatus, and receives and displays information stored in the server 3200 described later. The information processing apparatus 2500 mainly includes the electronic paper 2320 having the display unit 2321 and a control unit 2510, like in the fifth embodiment. Configurations and functions of the electronic paper 2320 having the display unit 2321 are identical to those of the fifth embodiment, and therefore redundant explanations will be omitted.

The control unit 2510 includes the ID storage unit 2315, the RFID detector 2311, the authenticating unit 2314, the transmitting/receiving unit 2312, and the display control unit 2313. The ID storage unit 2315, the RFID detector 2311, and the authenticating unit 2314 are identical to those of the fifth embodiment, and therefore redundant explanations will be omitted.

When the authenticating unit 2314 has successfully authenticated an ID of a constituent element, the transmitting/receiving unit 2312 transmits to the server 3200 the ID of the constituent element and a request for manual data of the constituent element. When the authenticating unit 2314 has successfully authenticated an ID of a constituent element, the transmitting/receiving unit 2312 receives the requested manual data of the constituent element from the server 3200 that receives the ID of the constituent element and the request for the manual data of the constituent element. The transmitting/receiving unit 2312 communicates following the communication protocol of the radio LAN such as the IEEE 802.11, like in the fifth embodiment. Any communication protocol that can transmit and receive manual data can be used, instead of the above protocol.

The display control unit 2313 controls the display of manual data received by the transmitting/receiving unit 2312, in the display unit 2321 of the electronic paper 2320.

Details of the server 3200 are explained next. The server 3200 transmits information stored in the server 3200 to the information processing apparatus 2500 stored in the server 3200, according to a request from the information processing apparatus 2500. The server 3200 mainly includes a storage unit 3204, a transmitting/receiving unit 3201, an obtaining unit 3202, and an updating unit 3203.

The storage unit 3204 stores manual data that explains a constituent element of the MFP 3100. In other words, the storage unit 3204 stores manual data of constituent elements such as manual data of the ADF 3001, manual data of the scanner unit 3002, or the like. This manual data describes an explanation and a method of operating each constituent element, and countermeasures against troubles. The storage unit 3204 also stores a table relating to types of MFPs, IDs of the constituent elements, and manual names of the constituent elements. The correspondence table stored in the storage unit 3204 is similar to that stored in the storage unit 3204 (see FIG. 34).

The transmitting/receiving unit 3201 receives from the information processing apparatus 2500 a fact that the information processing apparatus 2500 has authenticated an ID of a constituent element transmitted from any one of the RFID tags 3001a to 3006a to the information processing apparatus 2500, that the ID has been successfully authenticated, the ID of the constituent element, and a request for manual data of the constituent element. The transmitting/receiving unit 3201 transmits the manual data obtained by the obtaining unit 3202 described later to the information processing apparatus 2500.

When the transmitting/receiving unit 3201 has been successful in authenticating the ID of the constituent element transmitted from the RFID tag, the obtaining unit 3202 obtains manual data shown by a manual file name corresponding to the ID of the constituent element that has been successfully authenticated, from the storage unit 3204, using the ID of the constituent element that has been successfully authenticated.

The updating unit 3203 updates periodically or at random intervals the manual data stored in the storage unit 3204.

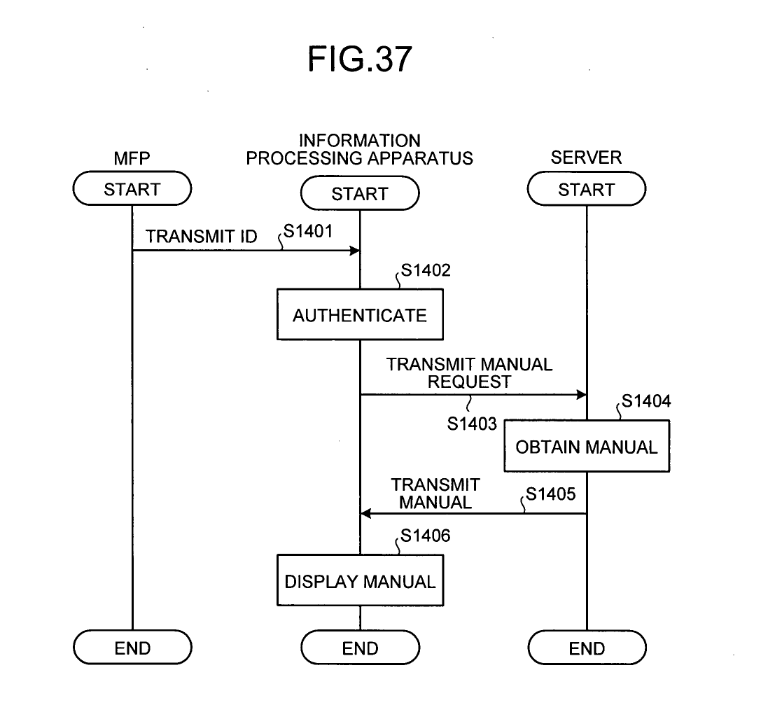

A display process performed by the display processing system having the above configuration is explained next. FIG. 37 is a sequence diagram of a display process procedure performed by the display processing system according to the seventh embodiment.

The process from the transmission of an ID of a constituent element according to an RFID tag to the authentication carried out by the authenticating unit 2314 (steps S1401, S1402) is similar to the corresponding process according to the fifth embodiment (steps S501, S502). Therefore, explanations of the above process will be omitted.

When the authenticating unit 2314 has been successful in authenticating the ID of the constituent element, the transmitting/receiving unit 2312 transmits this fact, the ID of the constituent element, and a request for the manual data of the constituent element to the server 3200 (step S1403). The transmitting/receiving unit 3201 of the server 3200 receives this information. When the obtaining unit 3202 receives a fact of the successful authentication of the ID of the constituent element, the ID of the constituent element, and the request for the manual data of the constituent element, the obtaining unit 3202 obtains the manual data of the constituent element corresponding to the received ID of the constituent element, from the storage unit 3204 (step S1404).

The transmitting/receiving unit 3201 transmits the manual data of the constituent element obtained by the obtaining unit 3202 to the information processing apparatus 2500 (step S1405). The transmitting/receiving unit 2312 of the information processing apparatus 2500 receives the manual data. The display control unit 2313 displays the manual data received by the transmitting/receiving unit 2312, in the display unit 2321 of the electronic paper 2320 (step S1406).

As explained above, according to the display processing system of the seventh embodiment, when the portable information processing apparatus 2500 is brought close to a constituent element of the MFP 3100, the information processing apparatus 2500 receives an ID of the corresponding one of the constituent elements of the RFID tags 3001a to 3006a provided near the constituent element. When the information processing apparatus 2500 has been successful in authenticating the received ID of the constituent element, the information processing apparatus 2500 transmits a manual data request to the server 3200. The manual data of the constituent elements of the server 3200 is received and displayed in the display unit 2321. With this arrangement, a user can obtain the manual data of the constituent element that the user wishes to read without searching the manual data, by only bringing the information processing apparatus 2500 close to the constituent element of which manual data is to be displayed. When the thin and light electronic paper 2320 of which displayed characters can be easily recognized is used for the information processing apparatus 2500, the user can carry the information processing apparatus 2500 instantly. Because the displayed characters can be easily recognized, even elderly people or people having weak eyesight can easily use this apparatus. Because the manual data of the constituent element stored in the server 3200 is updated periodically or at random intervals, the user can obtain the updated new manual. For example, the user can update the manual data immediately before the MFP 3100 is sold, or can add countermeasures against troubles.

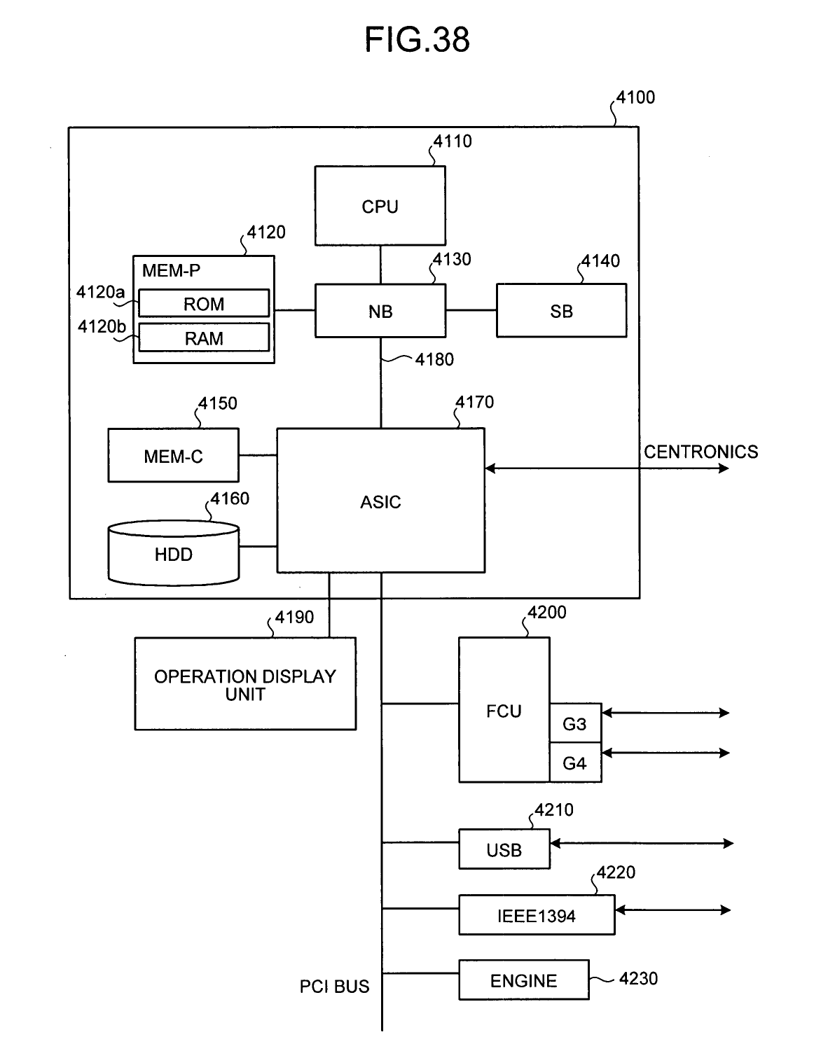

FIG. 38 is a block diagram of a hardware configuration of the MFP according to the fifth to seventh embodiments. As shown in FIG. 38, the MFPs 3000 and 3100 have a configuration that a controller 4100 and an engine unit 4230 are connected to each other via a Peripheral Component Internet (PCI) bus. The controller 4100 controls the total of the MFPs 3000 and 3100, communication, and input from an operating unit (not shown). The engine unit 4230 is a printer engine that can be connected to the PCI bus. The engine unit 4230 is a monochromatic plotter, a one-drum color plotter, a four-drum color plotter, a scanner, or a facsimile unit. The engine unit 4230 includes an image processing part such as an error spread and gamma conversion.

The controller 4100 includes a CPU 4110, a Northbridge (NB) 4130, a system memory (MEM-P) 4120, a Southbridge (SB) 4140, a local memory (MEM-C) 4150, an Application Specific Integrated Circuit (ASIC) 4170, and a hard disk drive (HDD) 4160. The NB 4130 and the ASIC 4170 are connected to each other with an Accelerated Graphics Port (AGP) bus 4180. The MEM-P 4120 further includes a ROM 4120a, and a RAM 4120b.

The CPU 4110 controls the total of the MFPs 3000 and 3100, has a chip set including the NB 4130, the MEM-P 4120, and the SB 4140, and is connected to other devices via this chip set.

The NB 4130 is a bridge that connects the CPU 4110 with the MEM-P 4120, the SB 4140, and the AGP BUS 4180, and includes a memory controller that controls the writing to the MEM-P 4120, and a PCI master, and an AGP target.

The MEM-P 4120 is a system memory that is used as a memory that stores a program and data, a development memory of a program and data, and a drawing memory of a printer. The MEM-P 4120 includes the ROM 4120a and the RAM 4120b. The ROM 4120a is a ROM used as a memory that stores a program and data. The RAM 4120b is a writable and readable memory that is used as a development memory of a program and data and as a drawing memory of a printer.

The SB 4140 is a bridge that connects between the NB 4130, the PCI device, and the peripheral device. The SB 4140 is also connected to the NB 4130 via the PCI bus. This PCI bus is also connected to the network I/F.

The ASIC 4170 is an integrated circuit (IC) for image processing having a hardware element for image processing, and has a role of a bridge that connects between the AGP BUS 4180, the PCI bus, the HDD 4160, and the MEM-C 4150. The ASIC 4170 includes a PCI target, an AGP master, an arbiter (ARB) that forms a core of the ASIC 4170, a memory controller that controls the MEM-C 4150, plural direct memory access controllers (DMAC) that rotate image data based on a hardware logic, and a PCI unit that transfers data to and from the engine unit 4230 via the PCI bus. The ASIC 4170 is connected to a facsimile control unit (FCU) 4200, a Universal Serial Bus (USB) 4210, and the IEEE 1394 I/F 4220, via the PCI bus. The operation display unit 4190 is directly connected to the ASIC 4170.

The MEM-C 4150 is a local memory that is used as a copy image buffer and a code buffer. The HDD 4160 is a storage that stores image data, programs, font data, and forms.

The AGP BUS 4180 is a bus interface for a graphics accelerator card proposed to increase the speed of graphic processing. By directly accessing the MEM-P 4120 at a high throughput, a graphics accelerator card is processed at a high speed.

A display processing program executed by the MFP 3000 or 3100 according to the fifth to seventh embodiments is provided by being incorporated in a ROM in advance.

A display processing program executed by the MFP 3000 or 3100 according to the fifth to seventh embodiments can be provided by being recorded on a computer-readable recording medium such as a CD-ROM, a flexible disk (FD), and a digital versatile disk (DVD), in a file of an installable format or an executable format.

A display processing program executed by the MFP 3000 or 3100 according to the fifth to seventh embodiments can be provided by being stored in a computer connected to a network such as the Internet, and downloaded via the network. Further, a display processing program executed by the MFP 3000 or 3100 according to the fifth to seventh embodiments can be provided or distributed via a network such as the Internet.

A display processing program executed by the MFP 3000 or 3100 according to the fifth to seventh embodiments has a module configuration including each of the above units (the obtaining unit and the transmitting/receiving unit). As actual hardware, the CPU (processor) reads the display processing program from the ROM, and executes the program, thereby loading each unit on the main storage device. With this arrangement, the obtaining unit and the transmitting/receiving unit are provided in the main storage unit.

According to the display processing system of the fifth embodiment, a user brings the information processing apparatus close to a constituent element of the information processing apparatus. Based on this operation, the information processing apparatus receives information of the constituent element stored in the image processing apparatus, and displays this information. However, according to a display processing system of the eighth embodiment, the information processing apparatus collectively stores the information of items to be read which is stored in a server in advance. When the information processing apparatus is brought close to an item to be read, the information processing apparatus receives identification information of this item, and displays the information of this item stored at each receiving time.

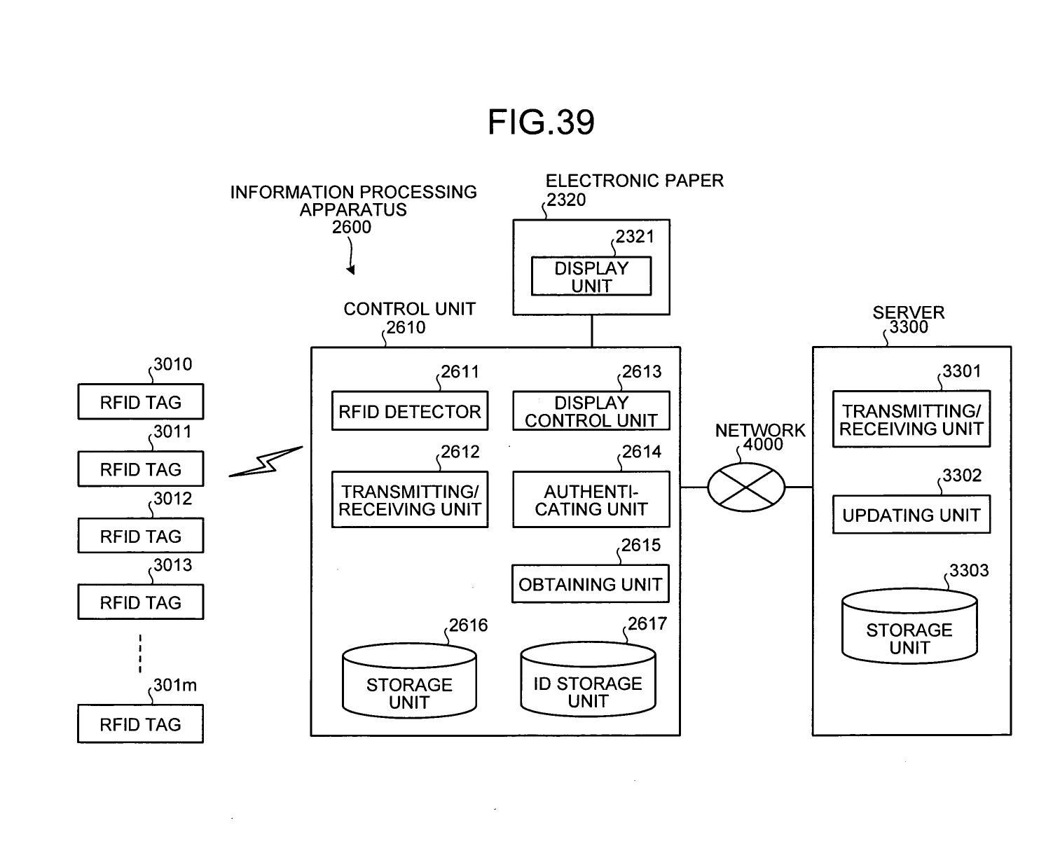

FIG. 39 is a block diagram of a configuration of the display processing system according to the eighth embodiment. As shown in FIG. 39, the display processing system according to the eighth embodiment includes RFID tags 3010 to 301m, an information processing apparatus 2600, and a server 3300. The information processing apparatus 2600 and the server 3300 are connected to the network 4000 such as a telephone line, a radio network, and the Internet. In the eighth embodiment, the image processing apparatus of the present invention is applied to an art museum, as an example. The RFID tags are provided near works such as paintings to be looked at. A visitor displays explanatory document data of a painting (information of a work to be looked at), using an information processing apparatus held by the visitor.

First, the RFID tags 3010 to 301m are explained. The RFID tags 3010 to 301m are provided near paintings exhibited in the art museum, corresponding to each painting. Each RFID tag includes an IC chip including a memory and a transmitting/receiving unit (not shown), and an antenna. Each memory of the RFID tags 3010 to 301m stores an ID of each painting as identification information own to each painting. Each RFID tag is a passive RFID tag that transmits the ID of a painting to the information processing apparatus 2600, when the transmitting/receiving unit receives a signal from the information processing apparatus 2600 within a predetermined range via the antenna.

Details of the information processing apparatus 2600 are explained next. The information processing apparatus 2600 has a size and weight in which the user can easily carry the apparatus. The information processing apparatus 2600 once stores information received from the server 3300, and displays the stored information. The information processing apparatus 2600 mainly includes the electronic paper 2320 having the display unit 2321 and a control nit 2610, like in the fifth embodiment. Configurations and functions of the electronic paper 2320 having the display unit 2321 are identical to those of the fifth embodiment, and therefore redundant explanations will be omitted.

The control unit 2610 includes an ID storage unit 2617, a storage unit 2616, a transmitting/receiving unit 2612, an RFID detector 2611, an authenticating unit 2614, an obtaining unit 2615, and a display control unit 2613.

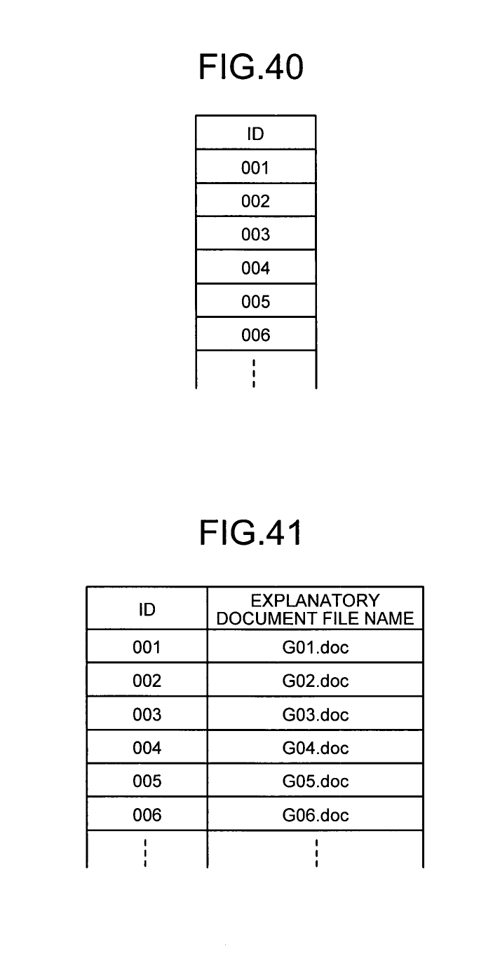

The ID storage unit 2617 stores an ID of a work such as a painting. FIG. 40 is one example of an ID of a work such as a painting stored in the ID storage unit 2617. As shown in FIG. 40, the ID storage unit 2617 stores IDs (001, 002) of works such as paintings.

The storage unit 2616 stores explanatory document data (relevant information) that explains a work such as a painting exhibited in the art museum. The storage unit 2616 stores explanatory document data that are related to each work. The explanatory document data of this work describes the date and time of creating the work, the profile of a creator or the like. The storage unit 2616 also stores a correspondence table having IDs of each work corresponded to an explanatory document file name of the work (relevant identification information). FIG. 41 is one example of a correspondence table stored in the storage unit 2616. As shown in FIG. 41, the correspondence table stores IDs (001, 002, etc.) of each work, and their explanatory document file names (AAA.doc, BBB.doc, etc.) by relating them to each other. The explanatory document and the correspondence table that are received from the server 3300 described later are stored in the storage unit 2616.

The transmitting/receiving unit 2612 transmits a request for explanatory document data and the correspondence table covering all works corresponding to the RFID tags 3010 to 301m, to the server 3300. The transmitting/receiving unit 2612 also collectively receives from the server 3300 the explanatory document data and the correspondence table covering all works corresponding to the RFID tags 3010 to 301m, and stores the received information in the storage unit 2616. The transmitting/receiving unit 2612 carries out communication following the communication protocol of the radio LAN such as the IEEE 802.11. The transmitting/receiving unit 2612 can use any communication protocol capable of transmitting and receiving manual data, instead of the above communication protocol.

When the information processing apparatus 2600 is brought close to any one the RFID tags 3010 to 301m provided near a work such as a painting, the RFID detector 2611 detects the ID of the work transmitted from any one of the RFID tags 3010 to 301m positioned within a predetermined range of distance from the information processing apparatus 2600. In other words, the RFID detector 2611 transmits a signal to any one the RFID tags 3010 to 301m within a communication range. When any one the RFID tags 3010 to 301m that has received the signal transmits the ID of the work, the transmitted ID of the work is detected in non-contact. The RFID detector 2611 can be configured to detect the ID of the work from any one of the active RFID tags 3001a to 3006a from which a signal is transmitted at a constant interval, when the information processing apparatus 2600 is brought close to the communication distance from this RFID.

When the RFID detector 2611 detects the ID of the work transmitted from any one of the RFID tags, the authenticating unit 2614 refers to the ID storage unit 2617, and checks whether the detected ID of the work is stored in this ID storage unit.

When the authenticating unit 2614 has been successful in authenticating the ID of the work transmitted from the RDFID tag, the obtaining unit 2615 obtains explanatory document data shown by the explanatory document file name corresponding to the authenticated ID of the work, from the storage unit 2616, using the authenticated ID as a key.

The display control unit 2613 controls the display of explanatory document data obtained by the obtaining unit 2615, in the display unit 2321 of the electronic paper 2320.

Details of the server 3300 are explained next. The server 3300 transmits the information stored in the server 3300 to the information processing apparatus 2600 according to a request from the information processing apparatus 2600. The server 3300 mainly includes a storage unit 3303, a transmitting/receiving unit 3301, and an updating unit 3302.

The storage unit 3303 stores a correspondence table having explanatory document data of a work such as a painting exhibited in the art museum, the ID of each work, and an explanatory document file name of the work, corresponded to each other, like the storage unit 2616. The correspondence table stored in the storage unit 3303 is similar to the correspondence table (see FIG. 41) stored in the storage unit 2616.

The transmitting/receiving unit 3301 receives from the information processing apparatus 2600 a request for explanatory document data requiring explanatory document data and the correspondence table. All explanatory document data of the works corresponding to the RFID tags 3010 to 301m and the correspondence table are collectively transmitted to the information processing apparatus 2600.

The updating unit 3302 updates periodically or at random intervals the explanatory document data stored in the storage unit 3303.

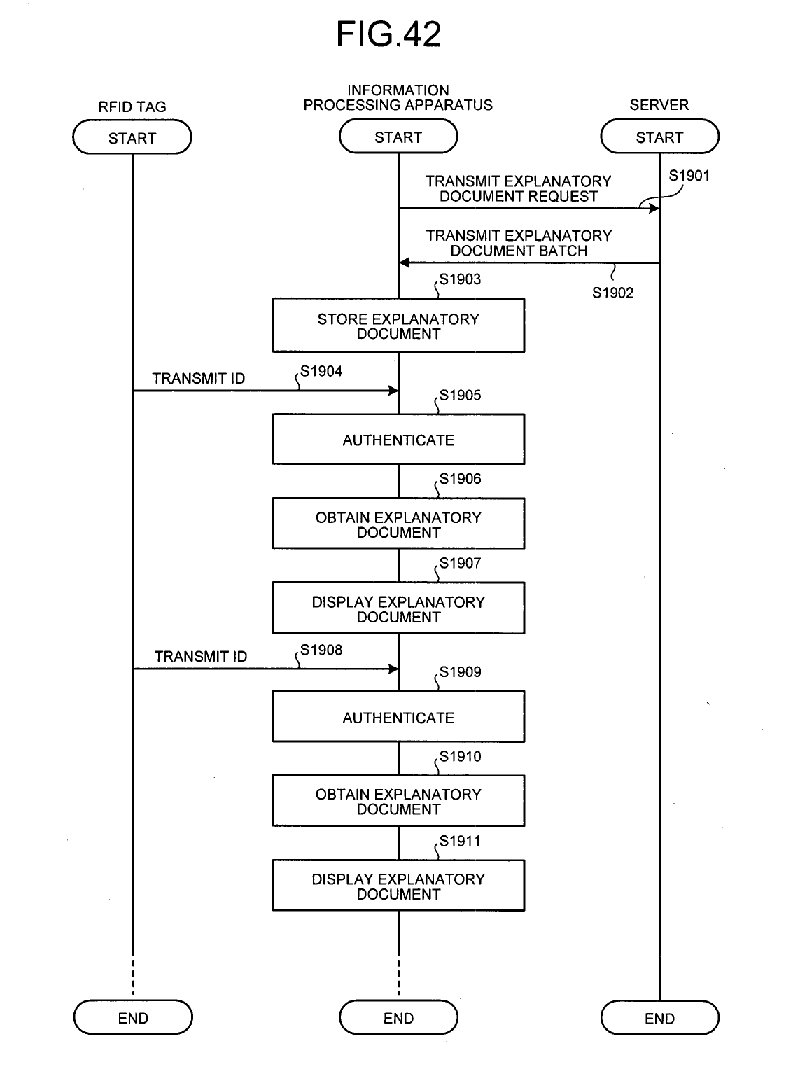

A display process performed by the display processing system having the above configuration is explained next. FIG. 42 is a sequence diagram of a display process procedure performed by the display processing system according to the eighth embodiment.

First, at an entrance of an art museum, the transmitting/receiving unit 2612 of the information processing apparatus 2600 transmits to the server 3300 an explanatory document data request for requesting explanatory document data of all works corresponding to the RFID tags 3010 to 301m and the correspondence table of the explanatory document data (step S1901). The transmitting/receiving unit 3301 of the server 3300 receives the explanatory document data request for requesting the explanatory document data and the correspondence table. The transmitting/receiving unit 3301 of the server 3300 collectively transmits to the information processing apparatus 2600 the explanatory document data request for requesting explanatory document data of all works corresponding to the RFID tags 3010 to 301m and the correspondence table of the explanatory document data (step S1902). The transmitting/receiving unit 2612 of the information processing apparatus 2600 collectively receives from the server 3300 the explanatory document data request for requesting explanatory document data of all works corresponding to the RFID tags 3010 to 301m and the correspondence table of the explanatory document data. The transmitting/receiving unit 2612 of the information processing apparatus 2600 stores in the storage unit 2616 the received explanatory document data of all works corresponding to the RFID tags 3010 to 301m and the correspondence table of the explanatory document data (step S1903).

When a user holding the information processing apparatus 2600 moves to look at a work in the art museum, the information processing apparatus 2600 is brought close to an RFID tag such as the RFID tag 3010 provided near the work to be looked at. When the information processing apparatus 2600 transmits a signal to the RFID tag 3010 within a communication distance, the RFID tag 3010 that receives this signal transmits the ID of the work to the information processing apparatus 2600 (step S1904). The RFID detector 2611 of the information processing apparatus 2600 detects the ID of the work transmitted from the RFID tag 3010. The authenticating unit 2614 then refers to the ID storage unit 2617, and checks whether the detected ID of the work is stored (step S1905).

When the authenticating unit 2614 has been successful in authenticating the ID of the work, the obtaining unit 2615 of the information processing apparatus 2600 obtains from the storage unit 2616 the explanation data of the work corresponding to the ID of the work near the RFID tag 3010 (step S1906). The display control unit 2613 displays in the display unit 2321 of the electronic paper 2320 the explanatory document data of the work near the RFID tag 3010 obtained by the obtaining unit 2615 (step S1907).

When the user holding the information processing apparatus 2600 moves to look at the next work, the information processing apparatus 2600 is brought close to an RFID tag such as the RFID tag 3011 provided near the work to be looked at. When the information processing apparatus 2600 transmits a signal to the RFID tag 3011 within a communication distance, the RFID tag 3011 that receives this signal transmits the ID of the work to the information processing apparatus 2600 (step S1908). The RFID detector 2611 of the information processing apparatus 2600 detects the ID of the work transmitted from the RFID tag 3011. The authenticating unit 2614 refers to the ID storage unit 2617, and checks whether the detected ID of the work is stored (step S1909).

When the authenticating unit 2614 has been successful in authenticating the ID of the work, the obtaining unit 2615 of the information processing apparatus 2600 obtains from the storage unit 2616 the explanation data of the work corresponding to the ID of the work near the RFID tag 3011 (step S1910). The display control unit 2613 displays in the display unit 2321 of the electronic paper 2320 the explanatory document data of the work near the RFID tag 3011 obtained by the obtaining unit 2615 (step S1911). When the user further moves to the next work, the RFID tag provided near this work transmits the ID of the work to the information processing apparatus 2600, and displays the explanatory document data of this work.

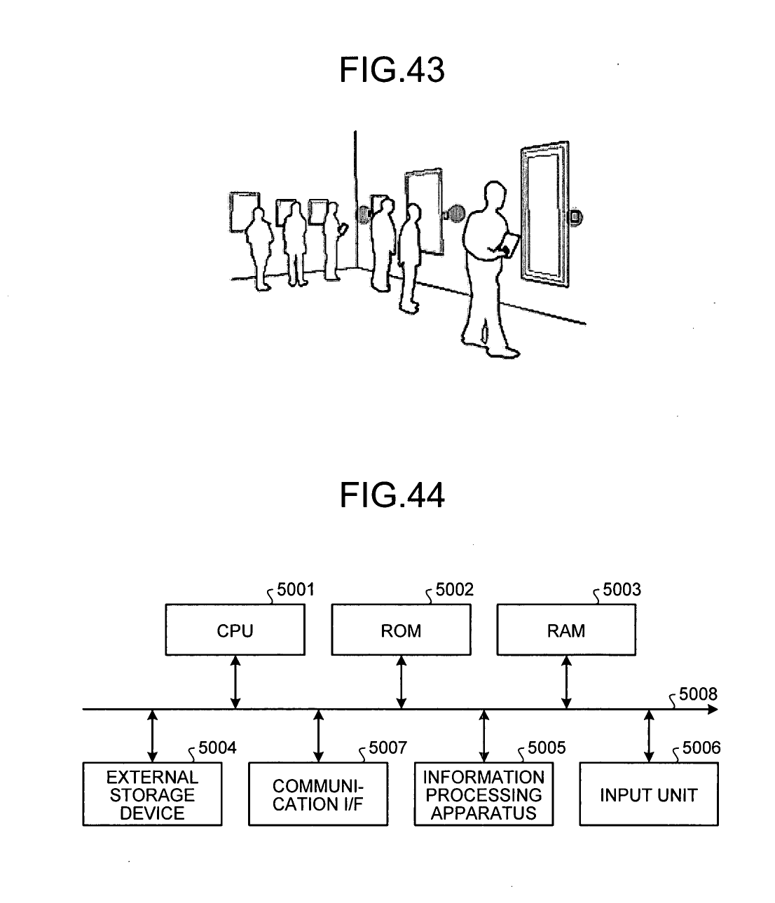

An example of a using state of the display processing system according to the eighth embodiment is explained next. FIG. 43 depicts the using state of the display processing system according to the eighth embodiment. FIG. 43 depicts a state that a user is moving to look at works by holding the information processing apparatus 2600. As shown in FIG. 43, when the user comes close to a work by holding the information processing apparatus 2600 to read an explanatory document of the product while looking at the work, the information processing apparatus 2600 is brought close to the RFID tag 3010 provided near the work, and the explanatory document data of the work is displayed in the information processing apparatus 2600. Accordingly, the user can read this explanatory document while looking at the work, without searching the explanatory document.

As explained above, the display processing system according to the eighth embodiment first collectively receives the explanatory document data of works from the server 3300, and stores the data in the information processing apparatus 2600. When the portable information processing apparatus 2600 is brought close to a work such as a painting to be looked at, the information processing apparatus 2600 receives the ID of this work from one of the RFID tags 3010 to 301m provided near the work. Upon successfully authenticating the received ID of the work, the information processing apparatus 2600 displays the explanatory document data of the stored work, in the display unit 2321. With this arrangement, when the information processing apparatus 2600 is brought close to the work of which explanatory document is to be displayed, a user can obtain the explanatory document data of a work to be looked at, without requiring a searching of the explanatory document data. When the thin and light electronic paper 2320 of which displayed characters can be easily recognized is used for the information processing apparatus 2600, the user can carry this apparatus instantly. Because the displayed characters can be easily recognized, even elderly people or people having weak eyesight can easily use this apparatus. Because the explanatory document data stored in the server 3300 is updated periodically or at random intervals, the user can obtain the updated new explanatory document data. For example, the user can update the explanatory document data following a change of the work, or can add explanatory document data when the number of works increases.

FIG. 44 is a block diagram of a hardware configuration of the information processing apparatus according to the fifth to eighth embodiments. The information processing apparatus according to the fifth to eighth embodiments includes a hardware configuration using a general computer. The information processing apparatus includes a control device such as a CPU 5001, storage units such as a ROM 5002 and a RAM 5003, an external storage device 5004 such as an HDD and a CD drive unit, an information processing apparatus 5005 (electronic paper) such as a display unit, an input unit 5006 such as a keyboard or a mouse, a communication I/F 5007, and a bus 5008 that connects these units.

While applications of electronic paper as an information processing apparatus has been described in the first to eighth embodiments, the electronic paper can be also applied to many other cases such as electronic advertising, as disclosed in Japanese Patent Laid-open No. 2003-162245, for example. Japanese Patent Laid-open No. 2003-162245 discloses a technique of instantly changing the content of advertising, making advantage of an image display based on electronic control of the electronic paper, and material compositions of the electronic paper.

The display processing program executed by the information processing apparatus according to the first to eighth embodiments can be provided by being recorded in a computer-readable recording medium such as a CD-ROM, an FD, a CD-R, and a DVD, in a file of an installable format or an executable format.

The display processing program executed by the information processing apparatus according to the first to eighth embodiments can be also provided by being stored in a computer connected to a network such as the Internet, and downloaded via the network. The display processing program executed by the information processing apparatus according to the first to eighth embodiments can be also provided or distributed via a network such as the Internet.

The display processing program according to the first to eighth embodiments can be also provided by being incorporated in a ROM or the like in advance. The display processing program executed by the information processing apparatus according to the first to eighth embodiments has a module configuration including the above units of the RFID detector, the transmitting/receiving unit, the authenticating unit, the obtaining unit, and the display control unit. As actual hardware, the CPU reads the display processing program from the above storage medium, and executes the program, thereby loading each unit on the main storage device. The RFID detector, the transmitting/receiving unit, the authenticating unit, the obtaining unit, and the display control unit are provided on the main storage device.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an electronic paper capable of displaying target data to be displayed; and
a control device that performs a control of processing, wherein
the electronic paper includes
a display unit that can electrically display and erase the target data, and
a first communication unit that exchanges data with the control device, and
the control device includes
a storage unit that stores the target data,
a display control unit that controls the display unit to display the target data stored in the storage unit, and
a second communication unit that exchanges data with the electronic paper.

2. The information processing apparatus according to claim 1, wherein the first communication unit and the second communication unit are radio communication interfaces.

3. The information processing apparatus according to claim 1, further comprising a holding unit that physically holds the electronic paper, wherein
the holding unit holds an end of the electronic paper.

4. The information processing apparatus according to claim 1, further comprising a holding unit that physically holds the electronic paper, wherein
the holding unit includes
an elastic member for elastically pressing an end of the electronic paper, and
a holding member that holds the electronic paper pressed by the elastic member.

5. The information processing apparatus according to claim 1, further comprising a holding unit that physically holds the electronic paper, wherein
the holding unit moves an end of the electronic paper in a sliding manner, and holds the end of the electronic paper.

6. The information processing apparatus according to claim 1, further comprising a holding unit that physically holds the electronic paper, wherein
the holding unit is capable of holding the electronic paper having different sizes.

7. The information processing apparatus according to claim 1, further comprising a holding unit that physically holds the electronic paper, wherein
the holding unit is capable of holding a plurality of electronic papers simultaneously.

8. An information processing apparatus comprising:
an electronic paper capable of displaying target data to be displayed; and
a control device that performs a control of processing, wherein
the electronic paper includes
a storage unit that stores the target data,
a display unit that can electrically display and erase the target data, and
a first communication unit that exchanges data with the control device, and
the control device includes
a display control unit that controls the display unit to display the target data stored in the storage unit, and
a second communication unit that exchanges data with the electronic paper.

9. The information processing apparatus according to claim 8, wherein the first communication unit and the second communication unit are radio communication interfaces.

10. The information processing apparatus according to claim 8, further comprising a holding unit that physically holds the electronic paper, wherein
the holding unit holds an end of the electronic paper.

11. The information processing apparatus according to claim 8, further comprising a holding unit that physically holds the electronic paper, wherein
the holding unit includes
an elastic member for elastically pressing an end of the electronic paper, and
a holding member that holds the electronic paper pressed by the elastic member.

12. The information processing apparatus according to claim 8, further comprising a holding unit that physically holds the electronic paper, wherein
the holding unit moves an end of the electronic paper in a sliding manner, and holds the end of the electronic paper.

13. The information processing apparatus according to claim 8, further comprising a holding unit that physically holds the electronic paper, wherein
the holding unit is capable of holding the electronic paper having different sizes.

14. The information processing apparatus according to claim 8, further comprising a holding unit that physically holds the electronic paper, wherein
the holding unit is capable of holding a plurality of electronic papers simultaneously.

15. An information processing apparatus comprising:
an electronic paper capable of displaying target data to be displayed; and
a control device that performs a control of processing, wherein
the electronic paper includes
a display unit that can electrically display and erase the target data,
a display control unit that controls the display unit to display the target data stored in the control device, and
a first communication unit that exchanges data with the control device, and
the control device includes
a storage unit that stores the target data, and
a second communication unit that exchanges data with the electronic paper.

16. The information processing apparatus according to claim 15, further comprising a holding unit that physically holds the electronic paper, wherein
the holding unit holds an end of the electronic paper.

17. The information processing apparatus according to claim 15, further comprising a holding unit that physically holds the electronic paper, wherein
the holding unit includes
an elastic member for elastically pressing an end of the electronic paper, and
a holding member that holds the electronic paper pressed by the elastic member.

18. The information processing apparatus according to claim 15, further comprising a holding unit that physically holds the electronic paper, wherein
the holding unit moves an end of the electronic paper in a sliding manner, and holds the end of the electronic paper.

19. The information processing apparatus according to claim 15, further comprising a holding unit that physically holds the electronic paper, wherein
the holding unit is capable of holding the electronic paper having different sizes.

20. The information processing apparatus according to claim 15, further comprising a holding unit that physically holds the electronic paper, wherein
the holding unit is capable of holding a plurality of electronic papers simultaneously.
